(19) United States
(12) Patent Application Publication
(10) Pub. No.: US 2022/0093000 A1
(43) Pub. Date: Mar. 24, 2022

(54) SYSTEMS AND METHODS FOR MULTIMODAL BOOK READING

(71) Applicant: Embodied, Inc., Pasadena, CA (US)

(72) Inventors: Mario E Munich, La Canada, CA (US); Stefan Scherer, Santa Monica, CA (US); Paolo Pirjanian, Glendale, CA (US); Craig Allen, Seattle, WA (US)

(21) Appl. No.: 17/606,728

(22) PCT Filed: Feb. 27, 2021
(86) PCT No.: PCT/US2021/020124

§ 371 Date: Oct. 26, 2021

Related U.S. Application Data
(60) Provisional application No. 62/983,591, filed on Feb. 29, 2020.
(60) Provisional application No. 63/154,554, filed on Feb. 26, 2021.

(51) Int. Cl. G09B 17/00; G09B 7/02; G09B 5/06; B25J 11/00; G06F 40/20; G06F 3/01

(52) U.S. Cl. CPC G09B 17/003; G09B 7/02; G06F 3/017; B25J 11/001; G06F 40/20; G09B 5/067

(57) ABSTRACT

Systems and methods to process reading articles for a multimodal book application are disclosed. Exemplary implementations may: identify a title of a reading article; store the title of the reading article in a database; scan two or more pages of the reading and generating text representing content of the reading article; analyze the generated text to identify characteristics of the reading article; store the identified characteristics in the database; associate the identified characteristics with the reading article title; generate augmented content files for one or more portions of the reading article based at least in part on the identified characteristics, and; and store the augmented content files in the database and associating the augmented content files with different portions of the reading article.

### RELATED APPLICATION

This application claims priority to U.S. provisional patent application Ser. No. 62/983,591, filed Feb. 29, 2020, entitled “Systems and Methods For Interactive, Multimodal Book Reading,” and 63,154,554, filed Feb. 26, 2021, entitled “Systems and Methods For Interactive, Multimodal Book Reading,” the entirety of which are both hereby incorporated by reference.

### FIELD OF THE DISCLOSURE

The present disclosure relates to systems and methods to process reading articles for a multimodal book application.

### BACKGROUND

When reading current media articles (e.g., such as books, comic books, newspapers, magazines, pamphlets), there is no feedback to a user. A user just reads the book and if they want more information about the reading article, they may login to the internet to research. In addition, in order to determine whether a child or user is understanding a reading article, a human has to monitor the user reading the reading article and inquire whether the user understands the concepts of the reading article. Accordingly, a multimodal system for processing, augmenting and analyzing reading articles (e.g., books, magazines, comic books, newspapers, pamphlets, other printed materials, etc.) is needed.

### SUMMARY

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1A illustrates a system for a social robot or digital companion to engage a child and/or a parent, in accordance with one or more implementations.

FIG. 1B illustrates a social robot or digital companion, in accordance with one or more implementations.

FIG. 1C illustrates modules or subsystems in a system where a child engages with a social robot or digital companion, in accordance with one or more implementations.

FIG. 2 illustrates a system architecture of an exemplary robot computing device, according to some implementations.

FIG. 3 illustrates a system configured to process reading articles for a multimodal book application, in accordance with one or more implementations.

FIG. 4A illustrates a method 400 to process reading articles for a multimodal book application, in accordance with one or more implementations;

FIG. 4B illustrates a process of a user engaging with the multimodal book reading system according to some implementations;

FIG. 4C illustrates on-the-fly processing of non-processed reading articles and utilization of the multimodal book reading system according to some implementations;

FIG. 5A illustrates a block diagram of modules in a system for interactive multimodal book reading according to some implementations;

FIG. 6A illustrates communication between a user or a consumer and a robot computing device (or digital companion) according to some embodiments.

FIG. 6B illustrates a user communicating with a robot computing device according to some embodiments.

FIG. 6C illustrates a user reading a book with the robot computing device according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Described herein is a multimodal system for processing, augmenting and analyzing reading articles. In some implementations, a reading article may be a book, magazine, comic book, newspaper, pamphlet, and/or other printed materials. In some implementations, these materials may be provided in printed form or electronic form (via ebooks or other software applications on tablets, computing devices and/or mobile communication devices). In some implementations, the multimodal book reading system presents a system for an interactive, multimodal device reading of a book. This patent application also applies to other reading articles such as books, encyclopedias, magazines, brochures, printed pamphlets and/or other printed material. In other parts of this specification, the term “reading article” may be utilized. In some implementations, to initiate book reading, a user may have an option to either speak out loud the name of the book and/or or to show a or point to the book's cover (or an internal page). In some implementations, the showing or pointing by the user may notify an imaging device to capture the name of the book to be read, text from the book to be read, and/or an image from the book to be read. Further, the multimodal book reading system may also proactively select a book at the user's appropriate reading level as well as selecting a book for the user to read, based off of past user interactions with the multimodal book reading system.

In some implementations, after the multimodal book reading system receives a selection of the book or reading article, then a user may begin to read the book. In some implementations, when a user starts to read the book or reading article, the robot computing device including the multimodal book reading system may follow the story and/or the user reading the book from one or more input sources or devices (e.g., the multiple modalities). In some implementations, the input devices may include: speech input from one or more microphones (since the book may be read out loud), vision (by having one or more imaging devices of the robot computing device capture), and/or radio frequency chips implemented inside the book (which may be captured by one or more RFID readers of the robot computing device). In some implementations, the robot computing device multimodal book reading system may include the ability or technology to recognize one or more specific pages in a book or reading article; and/or to recognize one or more pages from the words and/or phrases being read. In addition, the multimodal book reading system may also be able to recognize one or more specific pages in a book or reading article by looking at the book and/or even recognizing and/or following a finger pointing to the word or phrase. In some implementations, the multimedia book reading system may also have a multimodal output consisting of one or more speakers and audio processors to emit speech and sounds, a display to display graphics and/or to display facial expressions, and motors to move the robot computing device's appendages, neck and/or head or to interact with drive systems and/or wheels or treads to move a robot computing device to a new location and/or to move the robot head, neck, arms or shoulders to different positions. In some implementations, the multimodal output may be utilized to enhance the reading article experience. In some implementations, the movement or motion to a new location helps the robot computing device get better information (e.g., sound or images) on what a user is reading.

In some implementations, the multimodal book reading system may comprise a book database. In some implementations, the book database may comprise or include an extensive number of books that are pre-processed (scanned for relevant text, parameters and data). In some implementations, an asset database may include augmented content that allows a user to experience a high-fidelity experience of the book reading. In some implementations, the multimodal book reading system may know an exact pacing and/or content of the books that are pre-processed and stored in the database. In some implementations, the multimodal book reading system may generate questions to be asked to users, provide comments to users to improve understanding of the book, and/or to be able to assess a user's comprehension of the book. In some implementations, a user may have a book that has not been pre-processed by the multimodal book reading system, may be processed as they are being read by the users. In some implementations, the multimodal book reading system may, on-the-fly, analyze the unprocessed books or reading articles in order to locate and determine keywords, topics, other concepts from the books, identify characters, genres and/or identify a plot. In some implementations, the multimodal book reading system may perform these actions by scanning the pages of the books, utilizing one or more imaging devices to visually recognize objects, characters and/or images that are located in the book or reading article. In some implementations, the multimodal book reading system may also display and perform multimodal outputs appropriate to the mood of the book or reading article (e.g., suspenseful, funny, sad, etc.). In some implementations, for example, these performances or multimodal outputs may include but are not limited to playing music, displaying facial expressions, making gestures, generating vocal expressions or words (laughs and sighs), generating vocal comments, and creating visual reactions through movement of appendages, a neck and/or head of the robot computing device. In some implementations, the multimodal book reading device or system may automatically create questions and commentary based on the information collected during the reading. In some implementations such on-the-fly augmentation may be saved in the asset database to be used with other users of the multimodal book reading system.

In some implementations, the book database may receive book text and other book parameters or characteristics, from feeds from public databases, such as from Project Gutenberg, or through deals with publishers (e.g., such databases). In other words, publishers may agree to share electronic databases of their books. In some implementations, the robot computing devices multimedia book reader allows tracking of reading by the user. In some implementations, the multimodal book reader, because it tracks the user's progression, creates an ambiance for the reader by playing corresponding sounds and/or songs, changing the lights in the robot computing device display, showing facial gestures on the robot computing device display, and moving different parts of the robot computing device according to the story plot. In some implementations, the robot computing device multimodal book reader system may even be able to interrupt the reader or user, generate questions or comments, or to ask questions or comments to the user, which makes book reading an interactive experience that enables the reader to have a better comprehension of the text being read. In some implementations, the multimodal book reader system may interactively assess the level of reading comprehension of the reader. In some implementations, this type of interactive and multimodal reading system may be more engaging for readers and thus may potentially increase the number of young readers. In some implementations, the multimodal reading system may further assess the user's reading level based on objective assessment scores, including but not limited to a user's clarity of reading, speed of reading, fluency, reading comprehension, and/or also a vocabulary of books being read. In some implementations, these objective assessment scores guide the selection of new reading material to be suggested to the user to progress and/or advance the reading comprehension level.

In some implementations, the multimodal book reader provides advantages over other systems that are available. In some implementations, the multimedia book reader system includes multimodal input (audio, video, touch, RFID) and multimodal output (speech, sound, graphics, gestures, etc.) to assist and enhance reading a book (or reading material). In some implementations, the multimodal book reader system may initiate a book reading session by having a user select a title from a list of known or unknown books using speech input (and microphone capture), touch input, showing the book or reading material to the robot computing device, gesturing and/or pointing to the book or reading material, or inputting a selection of the book or reading material via the mouse or a keyboard. In some implementations, the multimodal book reader system may help a user select a book or reading material by proactively suggesting a book or reading material based on a description of the user (“I want to read a thriller”), past books or reading material that the user enjoyed, books or reading material that are within the user's reading abilities (children vs. adult books), or books or reading material that are identified by an algorithm (e.g., through a deal with a publisher, or via an advertisement for reading a new book or other reading material). In some implementations, when a user initiates reading of the book or reading material, the multimedia book reader system may follow the story from one or more input sources: e.g., speech input through one or more microphones (since the book is being read), vision input through one or more imaging devices, or reading radio frequency chips implemented inside the book or other reading material.

In some implementations, while following the story being read from the book, the robot computing device multimodal book reading system may generate or provide visual outputs, acoustic outputs, speech feedback, mobility commands and/or actions, and other augmentative material to enhance the story, comprehension, engagement, and improvement of reading skills for the reader or user. In some implementations, the multimodal book reading system may include a book database comprising an extensive number of books that are pre-processed. In some implementations, the books that are pre-processed may be augmented with content to allow for a high-fidelity experience of the book reading and that content may be stored in the asset database. In some implementations, the multimodal book reading system may be capable of interrupting the reader and ask questions or comments making book reading an interactive experience that enables the reader to have a better comprehension of the text being read. In some implementations, other books or reading material that is not pre-processed and stored in the book database may be processed (either separately or as a reader is reading the book). In some implementations, the multimodal book reading system may augment the newly processed book based on keywords, topics, concepts present in the book, or by utilizing other modalities to capture parts of the books, (e.g., such as visual recognition of objects, characters, scenes, etc.). In some implementations, the multimodal book reading device may automatically create questions and commentary based on the information collected during the reading. In some implementations, such on-the-fly augmentation of the book or reading material may be saved in the database to be used with other users of the multimodal book reading system. In some implementations, the multimodal book reading system may assess the reading level or the user or reader based on objective assessment scores, including but not limited to clarity of reading, speed of reading, fluency, reading comprehension, and/or vocabulary of books. In some implementations, the multimodal book reading system may calculate and/or generate the assessed information above and then report the assessed information to the user and/or other interested parties (e.g., parents, teachers, guardians, etc.). In some implementations, those objective assessment scores guide the selection of new reading material to be suggested to the user to progress and/or advance on the reading comprehension level.

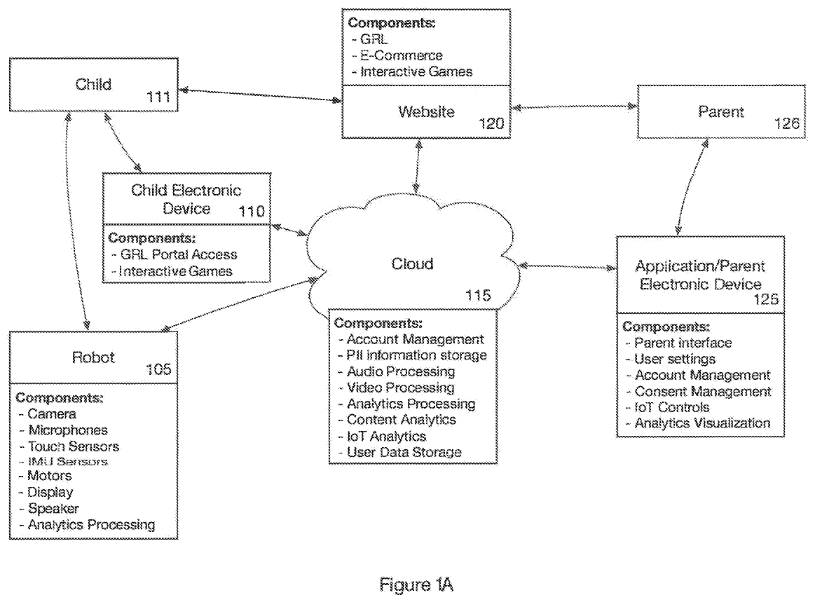

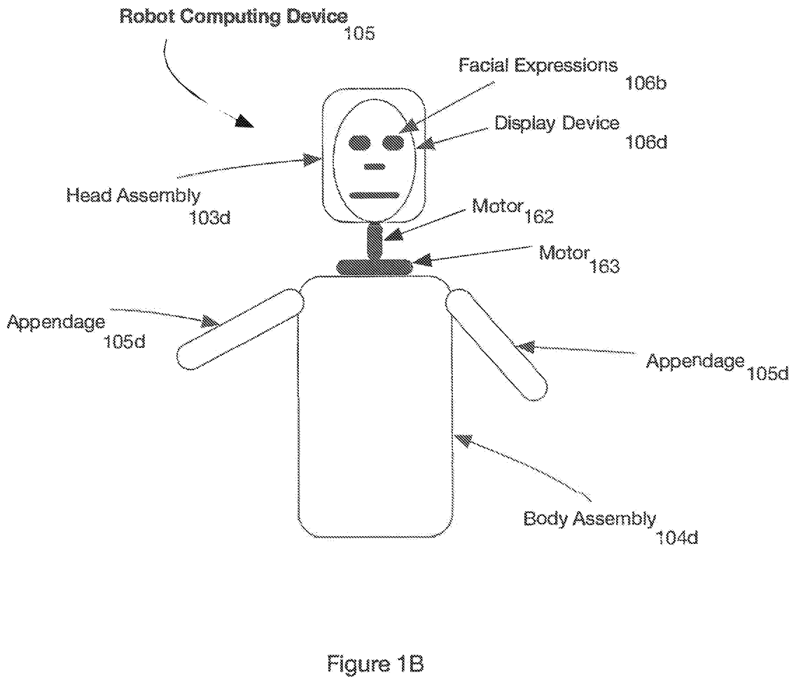

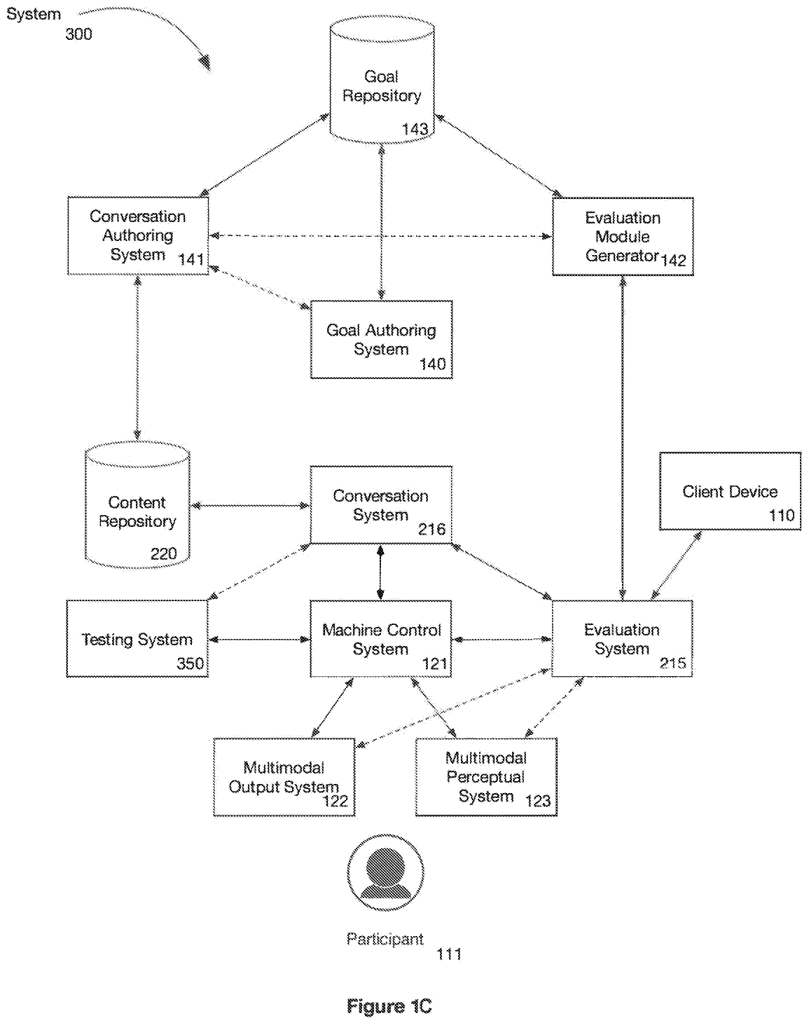

Although the term “robot computing device” is utilized, the teachings and disclosure herein apply also to digital companions, computing devices including voice recognition software, computing devices including gesture recognition software, computing devices including sound recognition software, and/or computing devices including facial recognition software or facial expression software. In some cases, these terms may be utilized interchangeably. FIG. 1A illustrates a system for a social robot or digital companion to engage a child and/or a parent, in accordance with one or more implementations. FIG. 1C illustrates modules or subsystems in a system where a child engages with a social robot or digital companion, in accordance with one or more implementations. FIG. 1B illustrates a social robot or digital companion, in accordance with one or more implementations. In some implementations, a robot computing device 105 (or digital companion) may engage with a child and establish communication interactions with the child. In some implementations, there will be bidirectional communication between the robot computing device 105 and the child 111 with a goal of establishing multi-turn conversations (e.g., both parties taking conversation turns) in the communication interactions. In some implementations, the robot computing device 105 may communicate with the child via spoken words (e.g., audio actions,), visual actions (movement of eyes or facial expressions on a display screen), and/or physical actions (e.g., movement of a neck or head or an appendage of a robot computing device). In some implementations, the robot computing device 105 may utilize imaging devices to evaluate a child's body language, a child's facial expressions and may utilize speech recognition software to evaluate, capture and/or record the child's speech.

In some implementations, the child may also have one or more electronic devices 110. In some implementations, the one or more electronic devices 110 may allow a child to login to a website on a server computing device or other cloud-based computing devices in order to access a learning laboratory and/or to engage in interactive games that are housed on the web site. In some implementations, the child's one or more computing devices 110 may communicate with cloud computing devices 115 in order to access the website 120. In some implementations, the website 120 may be housed on server computing devices or other cloud-based computing devices. In some implementations, the website 120 may include the learning laboratory (which may be referred to as a global robotics laboratory (GRL)) where a child can interact with digital characters or personas that are associated with the robot computing device 105. In some implementations, the website 120 may include interactive games where the child can engage in competitions or goal setting exercises. In some implementations, other users may be able to interface with an e-commerce website or program, (where the other users (e.g., child, parents or guardians) may purchases items that are associated with the robot (e.g., comic books, toys, badges or other affiliate items)).

In some implementations, the robot computing device or digital companion 105 may include one or more imaging devices, one or more microphones, one or more touch sensors, one or more IMU sensors, one or more motors and/or motor controllers, one or more display devices or monitors and/or one or more speakers. In some implementations, the robot computing devices may include one or more processors, one or more memory devices, and/or one or more wireless communication transceivers. In some implementations, computer-readable instructions may be stored in the one or more memory devices and may be executable to perform numerous actions, operations and/or functions. In some implementations, the robot computing device may perform analytics processing on data, parameters and/or measurements, audio files and/or image files that may be captured and/or obtained from the components of the robot computing device listed above.

In some implementations, the one or more touch sensors may measure if a user (child, parent or guardian) touches a portion of the robot computing device or if another object or individual comes into contact with the robot computing device. In some implementations, the one or more touch sensors may measure a force of the touch, dimensions and/or direction of the touch to determine, for example, if it is an exploratory touch, a push away, a hug or another type of action. In some implementations, for example, the touch sensors may be located or positioned on a front and back of an appendage or a hand of the robot computing device or on a stomach area of the robot computing device. Thus, the software and/or the touch sensors may determine if a child is shaking a hand or grabbing a hand of the robot computing device or if they are rubbing the stomach of the robot computing device. In some implementations, other touch sensors may determine if the child is hugging the robot computing device. In some implementations, the touch sensors may be utilized in conjunction with other robot computing device software where the robot computing device may be able to tell a child to hold their left hand if they want to follow one path of a story or hold a left hand if they want to follow the other path of a story.

In some implementations, the one or more imaging devices may capture images and/or video of a child, parent or guardian interacting with the robot computing device. In some implementations, the one or more imaging devices may capture images and/or video of the area around (e.g., the environment around) the child, parent or guardian. In some implementations, the one or more microphones may capture sound or verbal commands spoken by the child, parent or guardian. In some implementations, computer-readable instructions executable by the processor or an audio processing device may convert the captured sounds or utterances into audio files for processing. In some implementations, the captured video files, audio files and/or image files may be utilized to identify facial expressions and/or to help determine future actions performed or spoken by the robot device.

In some implementations, the one or more IMU sensors may measure velocity, acceleration, orientation and/or location of different parts of the robot computing device. In some implementations, for example, the IMU sensors may determine a speed of movement of an appendage or a neck. In some implementations, for example, the IMU sensors may determine an orientation of a section or the robot computing device, e.g., a neck, a head, a body or an appendage in order to identify if the hand is waving or In a rest position. In some implementations, the use of the IMU sensors may allow the robot computing device to orient its different sections (of the body) in order to appear more friendly or engaging to the user.

In some implementations, the robot computing device may have one or more motors and/or motor controllers. In some implementations, the computer-readable instructions may be executable by the one or more processors, and in response commands or instructions may be communicated to the one or more motor controllers to send signals or commands to the motors to cause the motors to move sections of the robot computing device. In some implementations, the sections may include appendages or arms of the robot computing device and/or a neck or a head of the robot computing device. In some implementations, the motors and/or motor controllers may control movement of the robot computing device from one position to another position (e.g., from location to location). In some implementations, the motors and/or motor controllers may interface with a drive system that is connected to wheels and/or a tread system to move the robot computing device.

In some implementations, the robot computing device may include a display or monitor. In some implementations, the monitor may allow the robot computing device to display facial expressions (e.g., eyes, nose, or mouth expressions), as well as to display video or messages to the child, parent or guardian. In some implementations, the display may also display graphic images to the child, parent or guardian.

In some implementations, the robot computing device may include one or more speakers, which may be referred to as an output modality. In some implementations, the one or more speakers may enable or allow the robot computing device to communicate words, phrases and/or sentences and thus engage in conversations with the user. In addition, the one or more speakers may emit audio sounds or music for the child, parent or guardian when they are performing actions and/or engaging with the robot computing device.

In some implementations, the system may include a parent computing device 125. In some implementations, the parent computing device 125 may include one or more processors and/or one or more memory devices. In some implementations, computer-readable instructions may be executable by the one or more processors to cause the parent computing device 125 to perform a number of operations and/or functions. In some implementations, these features and functions may include generating and running a parent interface for the system. In some implementations, the software executable by the parent computing device 125 may also alter user (e.g., child, parent or guardian) settings. In some implementations, the software executable by the parent computing device 125 may also allow the parent or guardian to manage their own account or their child's account in the system. In some implementations, the software executable by the parent computing device 125 may allow the parent or guardian to initiate or complete parental consent to allow certain features of the robot computing device to be utilized. In some implementations, the software executable by the parent computing device 125 may allow a parent or guardian to set goals or thresholds or settings what is captured from the robot computing device and what is analyzed and/or utilized by the system. In some implementations, the software executable by the one or more processors of the parent computing device 125 may allow the parent or guardian to view the different analytics generated by the system in order to see how the robot computing device is operating, how their child is progressing against established goals, and/or how the child is interacting with the robot computing device.

In some implementations, the system may include a cloud server computing device 115. In some implementations, the cloud server computing device 115 may include one or more processors and one or more memory devices. In some implementations, computer-readable instructions may be retrieved from the one or more memory devices and executable by the one or more processors to cause the cloud server computing device 115 to perform calculations and/or additional functions. In some implementations, the software (e.g., the computer-readable instructions executable by the one or more processors) may manage accounts for all the users (e.g., the child, the parent and/or the guardian). In some implementations, the software may also manage the storage of personally identifiable information in the one or more memory devices of the cloud server computing device 115. In some implementations, the software may also execute the audio processing (e.g., speech recognition and/or context recognition) of sound files that are captured from the child, parent or guardian, as well as generating speech and related audio file that may be spoken by the robot computing device 115. In some implementations, the software in the cloud server computing device 115 may perform and/or manage the video processing of images that are received from the robot computing devices.

In some implementations, the software of the cloud server computing device 115 may analyze received inputs from the various sensors and/or other input modalities as well as gather information from other software applications as to the child's progress towards achieving set goals. In some implementations, the cloud server computing device software may be executable by the one or more processors in order perform analytics processing. In some implementations, analytics processing may be behavior analysis on how well the child is doing with respect to established goals. In some implementations, analytics processing may be analyzing behavior on how well the child is doing in conversing with the robot (or reading a book or engaging in other activities) with respect to established goals.

In some implementations, the software of the cloud server computing device may receive input regarding how the user or child is responding to content, for example, does the child like the story, the augmented content, and/or the output being generated by the one or more output modalities of the robot computing device. In some implementations, the cloud server computing device may receive the input regarding the child's response to the content and may perform analytics on how well the content is working and whether or not certain portions of the content may not be working (e.g., perceived as boring or potentially malfunctioning or not working).

In some implementations, the software of the cloud server computing device may receive inputs such as parameters or measurements from hardware components of the robot computing device such as the sensors, the batteries, the motors, the display and/or other components. In some implementations, the software of the cloud server computing device may receive the parameters and/or measurements from the hardware components and may perform IOT Analytics or other analytics processing on the received parameters, measurements or data to determine if the robot computing device is malfunctioning and/or not operating at an optimal manner.

In some implementations, the cloud server computing device 115 may include one or more memory devices. In some implementations, portions of the one or more memory devices may store user data for the various account holders. In some implementations, the user data may be user address, user goals, user details and/or preferences. In some implementations, the user data may be encrypted and/or the storage may be a secure storage.

FIG. 1C illustrates functional modules of a system including a robot computing device according to some implementations. In some embodiments, at least one method described herein is performed by a system 300 that includes the conversation system 116, a machine control system 121, a multimodal output system 122, a multimodal perceptual system 123, and an evaluation system 215. In some implementations, at least one of the conversation system 216, a machine control system 121, a multimodal output system 122, a multimodal perceptual system 123, and an evaluation system 215 may be included in a robot computing device or a machine. In some embodiments, the machine may be a robot or robot computing device, or a digital companion device. In some implementations, the conversation system 216 may be communicatively coupled to control system 121 of the robot computing device. In some embodiments, the conversation system may be communicatively coupled to the evaluation system 215. In some implementations, the conversation system 216 may be communicatively coupled to a conversational content repository 220. In some implementations, the conversation system 216 may be communicatively coupled to a conversation testing system 350. In some implementations, the conversation system 216 may be communicatively coupled to a conversation authoring system 141. In some implementations, the conversation system 216 may be communicatively coupled to a goal authoring system 140. In some implementations, the conversation system 216 may be a cloud-based conversation system provided by a conversation system server that is communicatively coupled to the control system 121 via the Internet. In some implementations, the conversation system may be the Embodied Chat Operating System.

In some implementations, the conversation system 216 may be an embedded conversation system that is included in the robot computing device or implementations. In some implementations, the control system 121 may be constructed to control a multimodal output system 122 and a multi modal perceptual system 123 that includes one or more sensors. In some implementations, the control system 121 may be constructed to interact with the conversation system 216. In some implementations, the machine or robot computing device may include the multimodal output system 122. In some implementations, the multimodal output system 122 may include at least one of an audio output sub-system, a video display sub-system, a mechanical robotic subsystem, a light emission sub-system, a LED (Light Emitting Diode) ring, and/or a LED (Light Emitting Diode) array. In some implementations, the machine or robot computing device may include the multimodal perceptual system 123, wherein the multimodal perceptual system 123 may include the at least one sensor. In some implementations, the multimodal perceptual system 123 includes at least one of a sensor of a heat detection sub-system, a sensor of a video capture sub-system, a sensor of an audio capture sub-system, a touch sensor, a piezoelectric pressor sensor, a capacitive touch sensor, a resistive touch sensor, a blood pressure sensor, a heart rate sensor, and/or a biometric sensor. In some implementations, the evaluation system 215 may be communicatively coupled to the control system 121. In some implementations, the evaluation system 215 may be communicatively coupled to the multimodal output system 122. In some implementations, the evaluation system 215 may be communicatively coupled to the multimodal perceptual system 123. In some implementations, the evaluation system 215 may be communicatively coupled to the conversation system 216. In some implementations, the evaluation system 215 may be communicatively coupled to a client device 110 (e.g., a parent or guardian's mobile device or computing device). In some implementations, the evaluation system 215 may be communicatively coupled to the goal authoring system 140. In some implementations, the evaluation system 215 may include computer-readable-instructions of a goal evaluation module that, when executed by the evaluation system, may control the evaluation system 215 to process information generated from the multimodal perceptual system 123 to evaluate a goal associated with conversational content processed by the conversation system 216. In some implementations, the goal evaluation module is generated based on information provided by the goal authoring system 140.

In some implementations, the goal evaluation module 215 may be generated based on information provided by the conversation authoring system 140. In some embodiments, the goal evaluation module 215 may be generated by an evaluation module generator 142. In some implementations, the conversation testing system may receive user input from a test operator and may provide the control system 121 with multimodal output instructions (either directly or via the conversation system 216). In some implementations, the conversation testing system 350 may receive event information indicating a human response sensed by the machine or robot computing device (either directly from the control system 121 or via the conversation system 216). In some implementations, the conversation authoring system 141 may be constructed to generate conversational content and store the conversational content in one of the content repository 220 and the conversation system 216. In some implementations, responsive to updating of content currently used by the conversation system 216, the conversation system may be constructed to store the updated content at the content repository 220.

In some embodiments, the goal authoring system 140 may be constructed to generate goal definition information that is used to generate conversational content. In some implementations, the goal authoring system 140 may be constructed to store the generated goal definition information in a goal repository 143. In some implementations, the goal authoring system 140 may be constructed to provide the goal definition information to the conversation authoring system 141. In some implementations, the goal authoring system 143 may provide a goal definition user interface to a client device that includes fields for receiving user-provided goal definition information. In some embodiments, the goal definition information specifies a goal evaluation module that is to be used to evaluate the goal. In some implementations, each goal evaluation module is at least one of a sub-system of the evaluation system 215 and a sub-system of the multimodal perceptual system 123. In some embodiments, each goal evaluation module uses at least one of a sub-system of the evaluation system 215 and a sub-system of the multimodal perceptual system 123. In some implementations, the goal authoring system 140 may be constructed to determine available goal evaluation modules by communicating with the machine or robot computing device, and update the goal definition user interface to display the determined available goal evaluation modules.

In some implementations, the goal definition information defines goal levels for goal. In some embodiments, the goal authoring system 140 defines the goal levels based on information received from the client device (e.g., user-entered data provided via the goal definition user interface). In some embodiments, the goal authoring system 140 automatically defines the goal levels based on a template. In some embodiments, the goal authoring system 140 automatically defines the goal levels based information provided by the goal repository 143, which stores information of goal levels defined form similar goals. In some implementations, the goal definition information defines participant support levels for a goal level. In some embodiments, the goal authoring system 140 defines the participant support levels based on information received from the client device (e.g., user-entered data provided via the goal definition user interface). In some implementations, the goal authoring system 140 may automatically define the participant support levels based on a template. In some embodiments, the goal authoring system 140 may automatically define the participant support levels based on information provided by the goal repository 143, which stores information of participant support levels defined form similar goal levels. In some implementations, conversational content includes goal information indicating that a specific goal should be evaluated, and the conversational system 216 may provide an instruction to the evaluation system 215 (either directly or via the control system 121) to enable the associated goal evaluation module at the evaluation system 215. In a case where the goal evaluation module is enabled, the evaluation system 215 executes the instructions of the goal evaluation module to process information generated from the multimodal perceptual system 123 and generate evaluation information. In some implementations, the evaluation system 215 provides generated evaluation information to the conversation system 215 (either directly or via the control system 121). In some implementations, the evaluation system 215 may update the current conversational content at the conversation system 216 or may select new conversational content at the conversation system 100 (either directly or via the control system 121), based on the evaluation information.

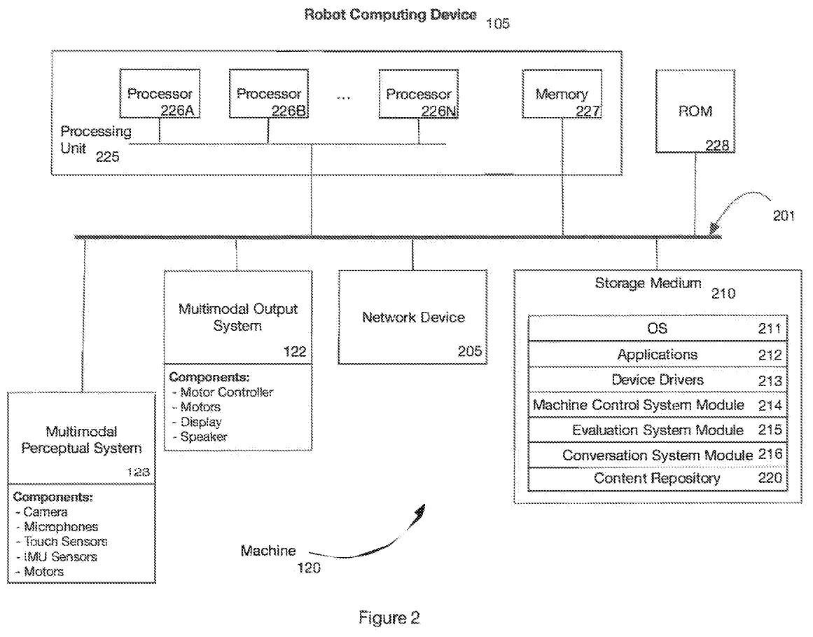

FIG. 1B illustrates a robot computing device according to some implementations. In some implementations, the robot computing device 105 may be a machine, a digital companion, a robot computing device, and/or an electro-mechanical device including computing devices. These terms may be utilized interchangeably in the specification. In some implementations, as shown in FIG. 1B, the robot computing device 105 may include a head assembly 103d, a display device 106d, at least one mechanical appendage 105d (two are shown in FIG. 1B), a body assembly 104d, a vertical axis rotation motor 163, and/or a horizontal axis rotation motor 162. In some implementations, the robot computing device may include a multimodal output system 122 and the multimodal perceptual system 123 (not shown in FIG. 1B, but shown in FIG. 2 below). In some implementations, the display device 106d may allow facial expressions 106b to be shown or illustrated after being generated. In some implementations, the facial expressions 106b may be shown by the two or more digital eyes, a digital nose and/or a digital mouth. In some implementations, other images or parts may be utilized to show facial expressions. In some implementations, the horizontal axis rotation motor 163 may allow the head assembly 103d to move from side-to-side which allows the head assembly 103d to mimic human neck movement like shaking a human's head from side-to-side. In some implementations, the vertical axis rotation motor 162 may allow the head assembly 103d to move in an up-and-down direction like shaking a human's head up and down. In some implementations, an additional motor may be utilized to move the robot computing device (e.g., the entire robot or computing device) to a new position or geographic location in a room or space (or even another room). In this implementation, the additional motor may be connected to a drive system that causes wheels, tires or treads to rotate and thus physically move the robot computing device.

In some implementations, the body assembly 104d may include one or more touch sensors. In some implementations, the body assembly's touch sensor(s) may allow the robot computing device to determine if it is being touched or hugged. In some implementations, the one or more appendages 105d may have one or more touch sensors. In some implementations, some of the one or more touch sensors may be located at an end of the appendages 105d (which may represent the hands). In some implementations, this allows the robot computing device 105 to determine if a user or child is touching the end of the appendage (which may represent the user shaking the user's hand).

FIG. 2 is a diagram depicting system architecture of robot computing device (e.g., 105 of FIG. 1B), according to implementations. In some implementations, the robot computing device or system of FIG. 2 may be implemented as a single hardware device. In some implementations, the robot computing device and system of FIG. 2 may be implemented as a plurality of hardware devices. In some implementations, the robot computing device and system of FIG. 2 may be implemented as an ASIC (Application-Specific Integrated Circuit). In some implementations, the robot computing device and system of FIG. 2 may be implemented as an FPGA (Field-Programmable Gate Array). In some implementations, the robot computing device and system of FIG. 2 may be implemented as a SoC (System-on-Chip). In some implementations, the bus 201 may interface with the processors 226A-N, the main memory 227 (e.g., a random access memory (RAM)), a read only memory (ROM) 228, one or more processor-readable storage mediums 210, and one or more network device 211. In some implementations, bus 201 interfaces with at least one of a display device (e.g., 102c) and a user input device. In some implementations, bus 101 interfaces with the multimodal output system 122. In some implementations, the multimodal output system 122 may include an audio output controller. In some implementations, the multimodal output system 122 may include a speaker. In some implementations, the multimodal output system 122 may include a display system or monitor. In some implementations, the multimodal output system 122 may include a motor controller. In some implementations, the motor controller may be constructed to control the one or more appendages (e.g., 105d) of the robot system of FIG. 1B. In some implementations, the motor controller may be constructed to control a motor of an appendage (e.g., 105d) of the robot system of FIG. 1B. In some implementations, the motor controller may be constructed to control a motor (e.g., a motor of a motorized, a mechanical robot appendage).

In some implementations, a bus 201 may interface with the multimodal perceptual system 123 (which may be referred to as a multimodal input system or multimodal input modalities. In some implementations, the multimodal perceptual system 123 may include one or more audio input processors. In some implementations, the multimodal perceptual system 123 may include a human reaction detection sub-system. In some implementations, the multimodal perceptual system 123 may include one or more microphones. In some implementations, the multimodal perceptual system 123 may include one or more camera(s) or imaging devices.

In some implementations, the one or more processors 226A-226N may include one or more of an ARM processor, an X86 processor, a GPU (Graphics Processing Unit), and/or the like. In some implementations, at least one of the processors may include at least one arithmetic logic unit (ALU) that supports a SIMD (Single Instruction Multiple Data) system that provides native support for multiply and accumulate operations.

In some implementations, at least one of a central processing unit (processor), a GPU, and a multi-processor unit (MPU) may be included. In some implementations, the processors and the main memory form a processing unit 225. In some implementations, the processing unit 225 includes one or more processors communicatively coupled to one or more of a RAM, ROM, and computer-readable storage medium; the one or more processors of the processing unit receive instructions stored by the one or more of a RAM, ROM, and computer-readable storage medium via a bus; and the one or more processors execute the received instructions. In some implementations, the processing unit is an ASIC (Application-Specific Integrated Circuit).

In some implementations, the processing unit may be a SoC (System-on-Chip). In some implementations, the processing unit may include at least one arithmetic logic unit (ALU) that supports a SIMD (Single Instruction Multiple Data) system that provides native support for multiply and accumulate operations. In some implementations the processing unit is a Central Processing Unit such as an Intel Xeon processor. In other implementations, the processing unit includes a Graphical Processing Unit such as NVIDIA Tesla.

In some implementations, the one or more network adapter devices or network interface devices 205 may provide one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers.

In some implementations, the one or more network devices 205 may be communicatively coupled to another robot computing device (e.g., a robot computing device similar to the robot computing device 105 of FIG. 1B). In some implementations, the one or more network devices 205 may be communicatively coupled to an evaluation system module (e.g., 215). In some implementations, the one or more network devices 205 may be communicatively coupled to a conversation system module (e.g., 110). In some implementations, the one or more network devices 205 may be communicatively coupled to a testing system. In some implementations, the one or more network devices 205 may be communicatively coupled to a content repository (e.g., 220). In some implementations, the one or more network devices 205 may be communicatively coupled to a client computing device (e.g., 110). In some implementations, the one or more network devices 205 may be communicatively coupled to a conversation authoring system (e.g., 160). In some implementations, the one or more network devices 205 may be communicatively coupled to an evaluation module generator. In some implementations, the one or more network devices may be communicatively coupled to a goal authoring system. In some implementations, the one or more network devices 205 may be communicatively coupled to a goal repository. In some implementations, machine-executable or computer-readable instructions in software programs (such as an operating system 211, application programs 212, and device drivers 213) may be loaded into the one or more memory devices (of the processing unit) from the processor-readable storage medium, the ROM or any other storage location. During execution of these software programs, the respective computer-executable instructions may be accessed by at least one of processors 226A-226N (of the processing unit) via the bus 201, and then may be executed by at least one of processors. Data used by the software programs may also be stored in the one or more memory devices, and such data is accessed by at least one of one or more processors 226A-226N during execution of the computer-executable instructions of the software programs.

In some implementations, the processor-readable storage medium 210 may be one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. In some implementations, the processor-readable storage medium 210 may include computer-executable instructions (and related data) for an operating system 211, software programs or application software 212, device drivers 213, and computer-executable instructions for one or more of the processors 226A-226N of FIG. 2.

In some implementations, the processor-readable storage medium 210 may include a machine control system module 214 that includes computer-executable instructions for controlling the robot computing device to perform processes performed by the machine control system, such as moving the head assembly of robot computing device.

In some implementations, the processor-readable storage medium 210 may include an evaluation system module 215 that includes computer-executable instructions for controlling the robotic computing device to perform processes performed by the evaluation system. In some implementations, the processor-readable storage medium 210 may include a conversation system module 216 that may include computer-executable instructions for controlling the robot computing device 105 to perform processes performed by the conversation system. In some implementations, the processor-readable storage medium 210 may include computer-executable instructions for controlling the robot computing device 105 to perform processes performed by the testing system. In some implementations, the processor-readable storage medium 210, computer-executable instructions for controlling the robot computing device 105 to perform processes performed by the conversation authoring system.

In some implementations, the processor-readable storage medium 210, computer-executable instructions for controlling the robot computing device 105 to perform processes performed by the goal authoring system. In some implementations, the processor-readable storage medium 210 may include computer-executable instructions for controlling the robot computing device 105 to perform processes performed by the evaluation module generator.

In some implementations, the processor-readable storage medium 210 may include the content repository 220. In some implementations, the processor-readable storage medium 210 may include the goal repository 180. In some implementations, the processor-readable storage medium 210 may include computer-executable instructions for an emotion detection module. In some implementations, emotion detection module may be constructed to detect an emotion based on captured image data (e.g., image data captured by the perceptual system 123 and/or one of the imaging devices). In some implementations, the emotion detection module may be constructed to detect an emotion based on captured audio data (e.g., audio data captured by the perceptual system 123 and/or one of the microphones). In some implementations, the emotion detection module may be constructed to detect an emotion based on captured image data and captured audio data. In some implementations, emotions detectable by the emotion detection module include anger, contempt, disgust, fear, happiness, neutral, sadness, and surprise. In some implementations, emotions detectable by the emotion detection module include happy, sad, angry, confused, disgusted, surprised, calm, unknown. In some implementations, the emotion detection module is constructed to classify detected emotions as either positive, negative, or neutral. In some implementations, the robot computing device 105 may utilize the emotion detection module to obtain, calculate or generate a determined emotion classification (e.g., positive, neutral, negative) after performance of an action by the robot computing device, and store the determined emotion classification in association with the performed action (e.g., in the storage medium 210).

In some implementations, the testing system may a hardware device or computing device separate from the robot computing device, and the testing system includes at least one processor, a memory, a ROM, a network device, and a storage medium (constructed in accordance with a system architecture similar to a system architecture described herein for the machine 120), wherein the storage medium stores computer-executable instructions for controlling the testing system 150 to perform processes performed by the testing system, as described herein.

In some implementations, the conversation authoring system may be a hardware device separate from the robot computing device 105, and the conversation authoring system may include at least one processor, a memory, a ROM, a network device, and a storage medium (constructed in accordance with a system architecture similar to a system architecture described herein for the robot computing device 105), wherein the storage medium stores computer-executable instructions for controlling the conversation authoring system to perform processes performed by the conversation authoring system.

In some implementations, the evaluation module generator may be a hardware device separate from the robot computing device 105, and the evaluation module generator may include at least one processor, a memory, a ROM, a network device, and a storage medium (constructed in accordance with a system architecture similar to a system architecture described herein for the robot computing device), wherein the storage medium stores computer-executable instructions for controlling the evaluation module generator to perform processes performed by the evaluation module generator, as described herein.

In some implementations, the goal authoring system may be a hardware device separate from the robot computing device , and the goal authoring system may include at least one processor, a memory, a ROM, a network device, and a storage medium (constructed in accordance with a system architecture similar to a system architecture described instructions for controlling the goal authoring system to perform processes performed by the goal authoring system. In some implementations, the storage medium of the goal authoring system may include data, settings and/or parameters of the goal definition user interface described herein. In some implementations, the storage medium of the goal authoring system may include computer-executable instructions of the goal definition user interface described herein (e.g., the user interface). In some implementations, the storage medium of the goal authoring system may include data of the goal definition information described herein (e.g., the goal definition information). In some implementations, the storage medium of the goal authoring system may include computer-executable instructions to control the goal authoring system to generate the goal definition information described herein (e.g., the goal definition information).

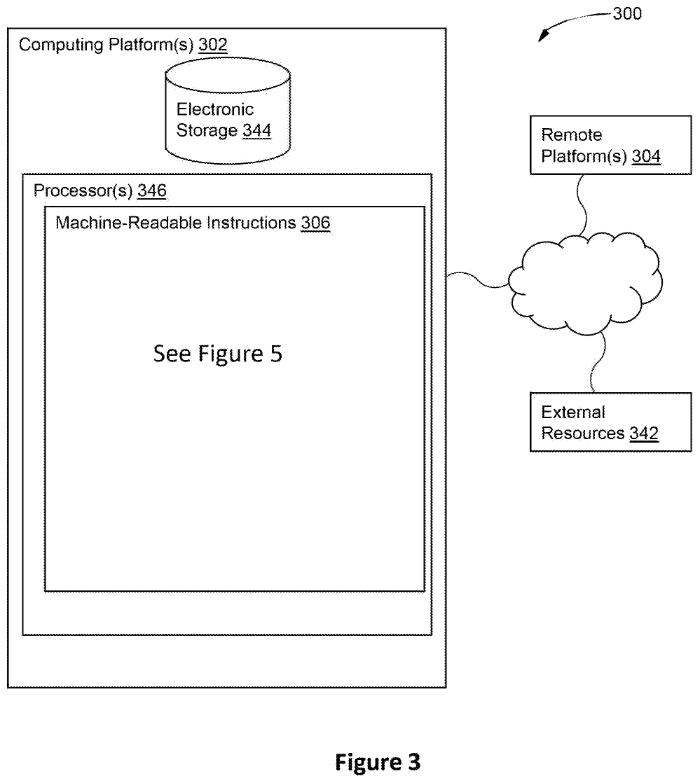

FIG. 3 illustrates a system 300 configured to process reading articles for a multimodal book application, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304. One or more components described in connection with system 300 may be the same as or similar to one or more components described in connection with FIGS. 1A, 1B, 1C and 2. For example, in some implementations, computing platform(s) 302 and/or remote platform(s) 304 may be the same as or similar to one or more of the robot computing device 105, the one or more electronic devices 110, the cloud server computing device 115, the parent computing device 125, and/or other components.

Computing platform(s) 302 may be configured by computer-readable instructions 306. Computer-readable instructions 306 may include one or more instruction modules. The instruction modules may include computer program modules.

Computing platform(s) 302 may include electronic storage 344, one or more processors 346, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 344 may comprise non-transitory storage media that electronically stores information. The electronic storage media of electronic storage 344 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 344 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 344 may include one or more virtual storage resources (e.g., cloud storage, a virtual private network, and/or other virtual storage resources). Electronic storage 344 may store software algorithms, information determined by processor(s) 346, information received from computing platform(s) 302, information received from remote platform(s) 304, and/or other information that enables computing platform(s) 302 to function as described herein.

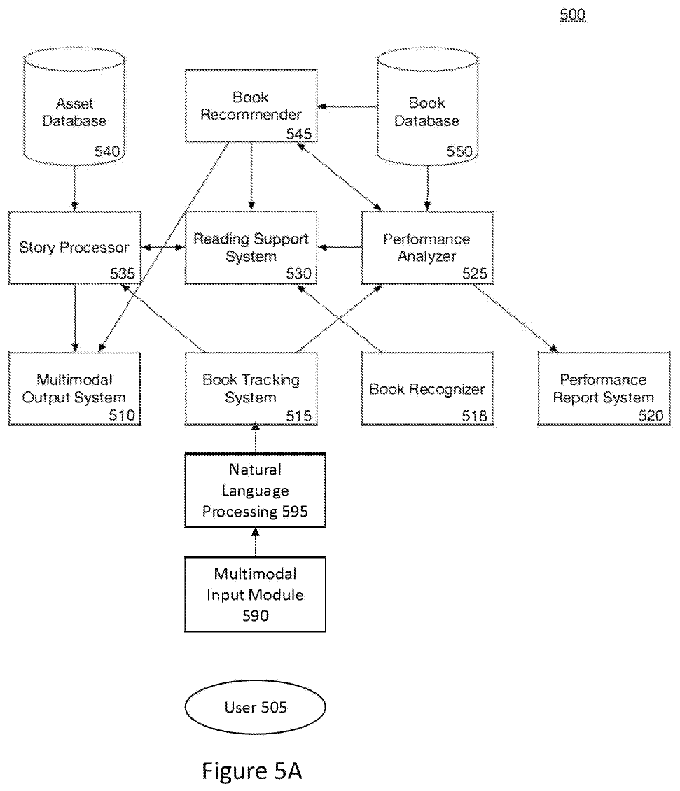

Processor(s) 346 may be configured to provide information processing capabilities in computing platform(s) 302. As such, processor(s) 346 may include one or more of a digital processor, an analog processor, a digital circuit designed to process information, an analog circuit designed to process information, a state machine, and/or other mechanisms for electronically processing information. Although processor(s) 346 is shown in FIG. 3 as a single entity, this is for illustrative purposes only. In some implementations, processor(s) 346 may include a plurality of processing units. These processing units may be physically located within the same device, or processor(s) 346 may represent processing functionality of a plurality of devices operating in coordination. Processor(s) 346 may be configured to execute modules 510, 515, 518, 520, 525, 530, 535, 540, 545, 550, 590, and/or 595 and/or other modules, as illustrated and described with respect to FIG. 5. Processor(s) 346 may be configured to execute modules 510, 515, 518, 520, 525, 530, 535, 540, 545, 550, 590, and/or 595 and/or other modules by software; hardware; firmware; some combination of software, hardware, and/or firmware; and/or other mechanisms for configuring processing capabilities on processor(s) 346. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 510, 515, 518, 520, 525, 530, 535, 540, 545, 550, 590, and/or 595 are illustrated in FIGS. 3 and 5 as being implemented within a single processing unit, in implementations in which processor(s) 346 includes multiple processing units, one or more of modules 510, 515, 518, 520, 525, 530, 535, 540, 545, 550, 590, and/or 595 may be implemented remotely from the other modules. The description of the functionality provided by the different modules 510, 515, 518, 520, 525, 530, 535, 540, 545, 550, 590, and/or 595 described below is for illustrative purposes, and is not intended to be limiting, as any of modules 510, 515, 518, 520, 525, 530, 535, 540, 545, 550, 590, and/or 595 may provide more or less functionality than is described. For example, one or more of modules 510, 515, 518, 520, 525, 530, 535, 540, 545, 550, 590, and/or 595 may be eliminated, and some or all of its functionality may be provided by other ones of modules 510, 515, 518, 520, 525, 530, 535, 540, 545, 550, 590, and/or 595. As another example, processor(s) 346 may be configured to execute one or more additional modules that may perform some or all of the functionality attributed below to one of modules 510, 515, 518, 520, 525, 530, 535, 540, 545, 550, 590, and/or 595.

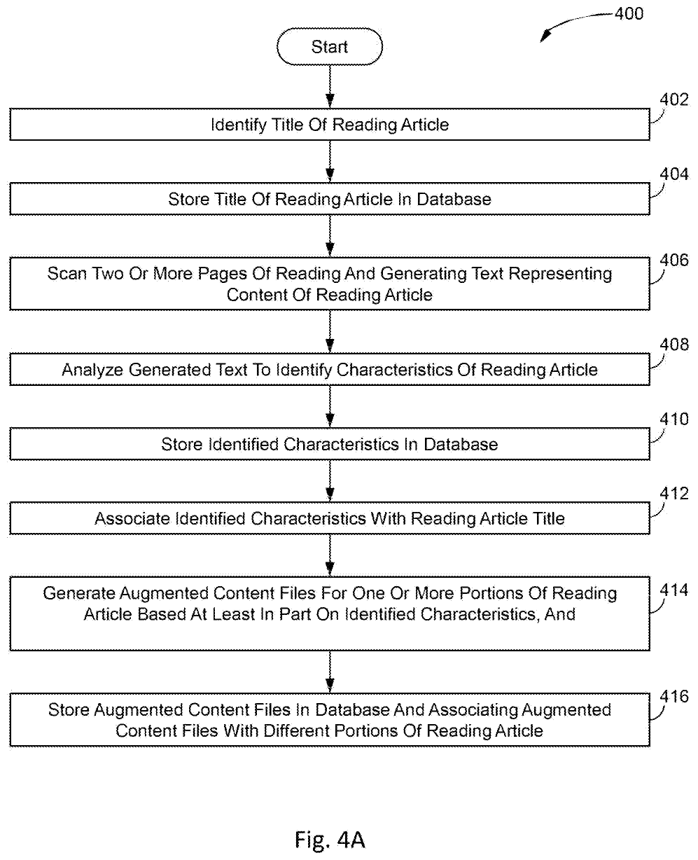

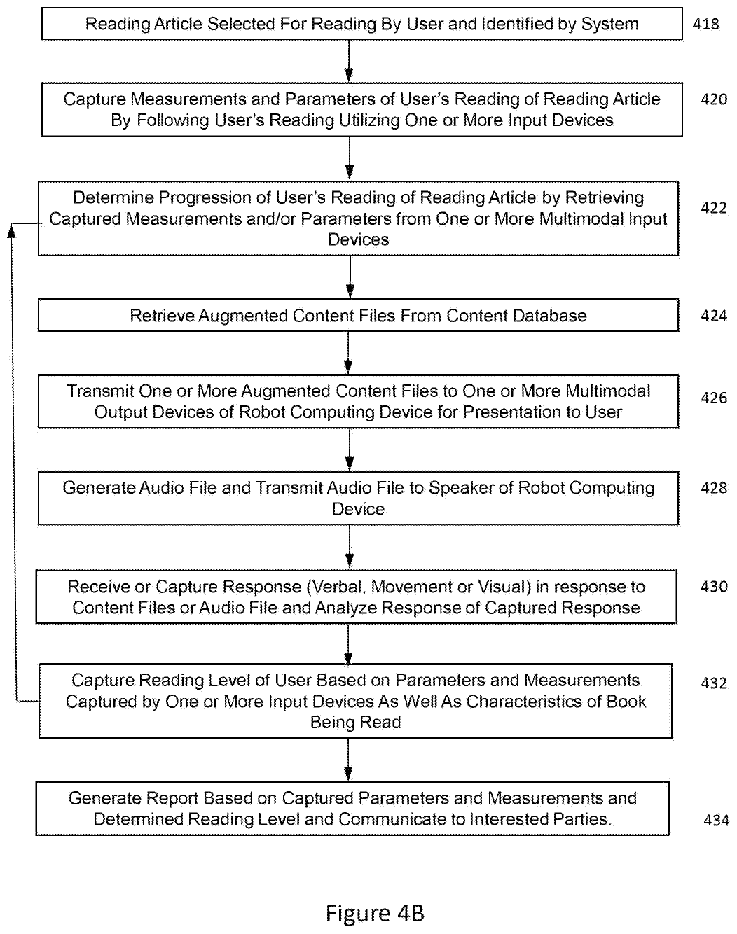

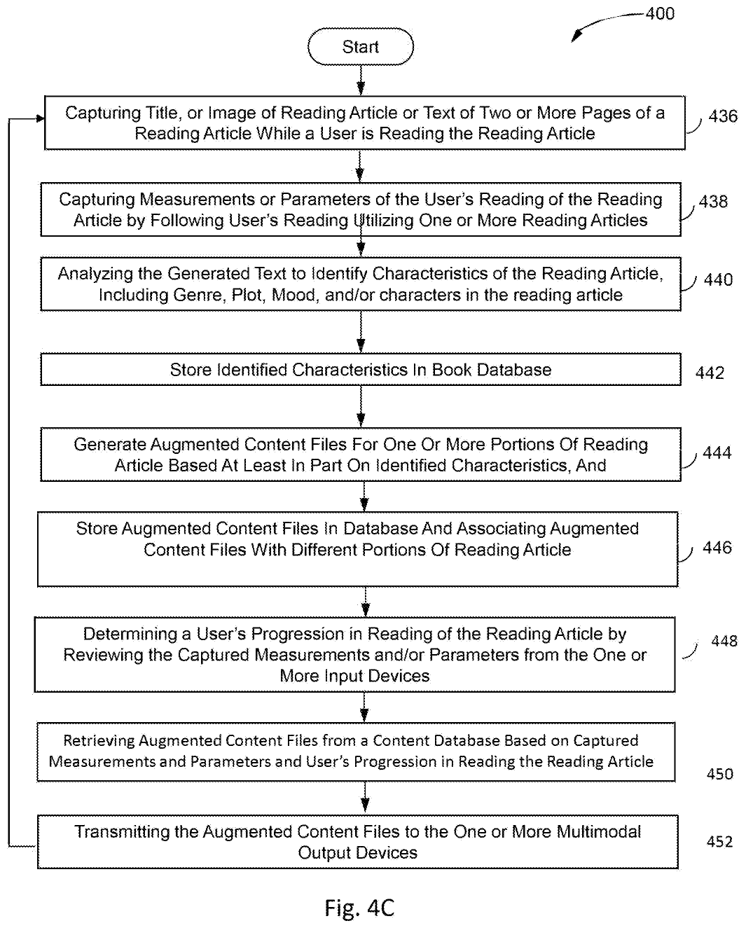

FIG. 4A illustrates a method 400 to process reading articles for a multimodal book application, in accordance with one or more implementations. As discussed previously, a reading article may be a book, a magazine, a newspaper, a comic book, a printed periodical, a pamphlet or other written material. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

FIG. 4A illustrates operation of a book processor module in a multimodal book reading system according to some implementations. In some implementations, the multimodal book reading system may process reading articles in order to have users engage in a better reading experience. In some implementations, an operation 402 may include identifying a title of a reading article. As discussed previously, in some implementations, a robot computing device may identify a book title by scanning a cover of a book and/or capturing (through optical character recognition or other similar technologies), a title of the book. In some implementations, the book processing module may also scan one or more images of a book cover. In some cases, the book processing module may also receive titles from deals with publishers or by other data feeds, such as from Project Gutenberg. In some implementations, the book processing module may also receive spoken words in order to identify book titles and in other implementations. In some implementations, the book processing module may also receive computing device input in order to identify the book title. In some implementations, operation 402 may receive spoken words that identify the title or may receive an input from a keyboard or a mouse (or similar devices) to identify a book title. Operation 402 may be performed by one or more hardware processors configured by computer-readable instructions including the software and/or hardware modules identified in FIG. 5A, in accordance with one or more implementations.

In some implementations, an operation 404 may include storing the title of the reading article in the book database 550. In some implementation, this may create database records for the reading article title, which will be populated with additional information and characteristics of the reading article. In some implementations, such additional information might be manually added, in some others, the additional information may be collected from electronically available sources, and in some others, the additional information may be generated by automatically processing information acquired during the user reading of the reading materials. Operation 404 may be performed by one or more hardware processors configured by computer-readable instructions including the software and/or hardware modules identified in FIG. 5A, in accordance with one or more implementations.

In some implementations, an operation 406 may include scanning two or more pages of the reading article and generating text representing content of the reading article. In some implementations, the operation 406 may scan a small portion or a significant portion or all of the pages of the reading article. In some implementations, this allows the book processor module to capture relevant portions of the reading article. In some implementations, operation 406 may not be needed because the text of the reading article may be provided by third-party computing systems (e.g., such as from Project Gutenberg or other book repository systems or software programs) or may be provided by publishers. In some implementations, the book processor may also capture images from pages of the reading article. In some implementations, these images may be stored in the book database 550 and associated or linked with the stored book title. In some implementations, operation 406 may be performed by one or more hardware processors configured by computer-readable instructions including a book processor or story processor module, in accordance with one or more implementations.

In some implementations, an operation 408 may include analyzing the generated text of the reading article to identify characteristics of the reading article or book. In some implementations, the book or story processor module may identify characters, plot, genre, and/or vocabulary level, as well as other characteristics of the book. In some implementations, third parties (e.g., public domain databases, review companies and/or publishers) may also communicate characteristics of reading articles to the book processing module. Operation 408 may be performed by one or more hardware processors configured by computer-readable instructions including a module that is the same as or similar to the book or story processor module, in accordance with one or more implementations.

In some implementations, an operation 410 may include storing the identified characteristics of the reading articles in the book database 550. In some implementations, operation 410 may be performed by one or more hardware processors configured by computer-readable instructions including a book processing module and/or the book database, in accordance with one or more implementations.

In some implementations, an operation 412 may include associating the identified characteristics with the reading article title in the book database. For example, a book title may be “Moby Dick,” and the characteristics may include the characters in the book, the plot, the reading level and other relevant characteristics. In some implementations, operation 412 may be performed by one or more hardware processors configured by computer-readable instructions including a book or story processing module, in accordance with one or more implementations.

In some implementations, an operation 414 may include generating augmented content files for one or more portions of the reading article. In some implementations, the augmented content may be visual content (e.g., graphics or facial expression for a display of the robot computing device), audio content (e.g., spoken words, sounds or music), or motion-related content (e.g., content to make the robot computing device to shrug, raise its hand, move, dance, or move its head up and down). In some implementations, the generated augmented content may be based on the captured text from the reading article (e.g., there is a cow so a “moo” sound is generated or there is an airplane and a jet engine sound may be generated or utilized). In some implementations, the generated augmented content may be based, at least in part, on the identified characteristics of the reading article. For example, if a book is identified as an adventure thriller, then certain music may be selected to be played. As another example, if a section of the reading article includes a depressing or sad scene, instructions for facial expressions may be generated to cause the robot computing device to display a sad facial expression during that section of the reading article. In some implementations, operation 414 may be performed by one or more hardware processors configured by computer-readable instructions including a book or story processing module, in accordance with one or more implementations.

In some implementations, an operation 416 may include storing the augmented content files in the asset database 540 and associating the augmented content files with different portions of the reading article, as well as the reading article record in the book database 550. In some implementations, operation 416 may be performed by one or more hardware processors configured by computer-readable instructions including a book processing module, in accordance with one or more implementations. In some implementations, this completes the description of the book or story processing module.

FIG. 4B illustrates a process of a user engaging with the multimodal book reading system according to some implementations. In some implementations, a user must select a reading article to begin reading and communicate this selection of the reading article to the multimodal book reading system. In some implementations, an operation 418 may include selecting a reading article for reading by a user. In some implementations, the user may identify the reading article through a voice command. In some implementations, a user may identify the reading article by showing the reading article cover (or even pages of the reading article to the robot computing device). In some implementations, the book recognizer module 518 may capture the title or an image from the cover (or text from or images of other pages) and compare this to stored titles, images and/or passages for processed reading articles (e.g., books, comic books, magazines, newspapers, etc.) in the book database 550 in order to determine the reading article title being read by the user. In some implementations, the user may identify the book by inputting the book name into a computing device (e.g., via a keyboard or mouse). In some implementations, the user may gesture to the reading article and the book recognizer module 518 may utilize one (or many) of the above input modalities to identify which reading article is being read. In some implementations, operation 418 may be performed by one or more hardware processors configured by computer-readable instructions including a book recognizer module 518, in accordance with one or more implementations.

In some implementations, the user or reader may read the reading article while the robot computing device is in the same area (e.g., next to the user so the robot computing device can see the reading article or facing the user where the device can also see portions of the reading article). In some implementations, an operation 420 may include capturing measurements and/or parameters of the user's reading of the reading article by following the user's reading utilizing one or more multimodal input devices. In some implementations, the capturing of measurements and/or parameters may include capturing a user's voice as they are reading a book in order to later analyze voice inflection, reading speed, pronunciation and other characteristics. In some implementations, the capturing of measurements and/or parameters may include using one or more imaging devices to capture a user's body posture, facial expression, and/or gestures and which will later be utilized to determine the measurements and/or parameters of the reading article. In some implementations, the capturing of measurements and/or parameters may include using the one or more imaging devices to capture pages, words and/or illustrations from the book as the user is reading the book. In some implementations, the book tracking system 515 may also communicate with the story processor module 535 to identify where (e.g., what page and/or paragraph) in the reading article the user currently is located. Operation 420 may be performed by one or more hardware processors configured by computer-readable instructions including a book tracking system 515 and/or a performance analyzer module 525, in accordance with one or more implementations.

In some implementations, an operation 422 may include determining a user's progression of the user's reading of the reading article by reviewing the captured measurements and/or parameters captured by the one or more multimodal input devices. In some implementations, the performance analyzer module 525 may utilize the captured measurements and parameters to identify a user's reading comprehension level, whether or not the user is pronouncing the words in the reading article correctly, a vocabulary level for the reading article, a reading speed for the user and whether this is an appropriate reading speed, whether the user is struggling in reading, etc. In some implementations, operation 422 may be performed by one or more hardware processors configured by computer-readable instructions including a book tracking system module and/or the performance analyzer module 525, in accordance with one or more implementations.

In some implementations, the multimodal book reading system may be able to augment the reading experience by providing additional audible effects (sounds, music and/or voices), visual effects (graphics and/or facial expressions) and/or robot computing device movements (e.g., hand waving, shaking of head in approval; going to a more friendly posture, dancing; or moving) through the multimodal outputs of the robot computing device or digital companion. In order to provide this augmented content, the robot computing device must first retrieve the augmented content. In some implementations, an operation 424 may include retrieving augmented content files, audio files, visual effect or action files, and/or movement instructions from an asset database 540. The retrieval of the augmented content files based at least in part on the captured measurements and/or parameters and the user's progression in advancing through reading of the reading article. In some implementations, a reading system support module 530 may receive input from the performance analyzer module 525 or book tracking system including the user's parameters, measurements and/or statistics and may determine next best options for interaction by the robot computing device. In other words, the reading support system module 530 may be a broker that determines next steps or interactions of the robot computing device with the user. In some implementations, for example, a reading system support module 530 may receive statistics and/or parameters from the performance analyzer module 525 and may determine that there is a question whether the reader is truly comprehending the reading material (e.g., there were mispronounced words or the user is reading too fast). In some implementations, for example, the reading support system 530 may recommend that questions be asked to the reader to verify that the user is comprehending the reading material. In some implementations, the reading support system 530 may ask the story processor module 535 to retrieve one or more appropriate questions from the asset database 540 that are to be output to the user. In some implementations, the questions may then be sent to the audio processing subsystem and/or speakers in the robot computing device. In some implementations, for example, the reading support system 530 may identify that the user is in a section that includes specific contexts (e.g., a scene with farm animals) and may communicate instructions or commands to the story processor module 535 to retrieve sound files and/or visual effect files (e.g., farm animal sounds and/or graphics of farm animals) from the asset database 540 and then communicate these through the robot computing device output modalities (e.g., the audio processing module and/or speakers and/or display of the robot computing device). In some implementations, operation 424 may be performed by one or more hardware processors configured by computer-readable instructions including a reading system support module 530, a story processor module 535 and/or the asset database 540, in accordance with one or more implementations.

In some implementations, an operation 426 may include transmitting the one or more augmented content files to at least one of the one or more multimodal output devices of the robot computing device (e.g., the audio system, the monitor and/or the motors or motor controllers of the robot computing device) for presentation to the user. In some implementations, operation 426 may be performed by one or more hardware processors configured by computer-readable instructions including a story processor module 535 and/or multimodal output system 510, in accordance with one or more implementations. In some implementations, the motors and/or motor controllers may interact with drive systems and/or wheels or treads to move a robot computing device to a new location or position, to change facial expressions or to play certain sound files.

One of the examples of generating and transmitting audio content is speaking a question about the reading article to a user. In some implementations, an operation 428 may include further including generating an audio file and transmitting the audio file to a speaker of the robot computing. In some implementations, the audio file may represent a question or comments to be audibly played to the user to request a response from the user. Operation 428 may be performed by one or more hardware processors configured by computer-readable instructions including a story processor module 535 and/or the multimodal output system 510, in accordance with one or more implementations.

In some implementations, a user may respond to actions (e.g., verbal actions, visual actions and/or movement actions) of the robot computing device. In some implementations, an operation 430 may include further including receiving a response from the user and/or analyzing the response by the robot computing device to further determine a user's comprehension of the reading article (e.g., or other parameters or measurements). In some implementations, the received response may be a response audio file and the response audio file may be analyzed by the robot computing device to identify reading comprehension of other parameters. In some implementations, the received response may be a gesture made by the user or an action taken by the user (raising their hand, shaking their head up and down), which may be captured by the one or more imaging devices and/or sensors, and then analyzed to determine reading comprehension of the user along with other parameters. This analysis may be performed by the performance analyzer module and the input may be received by the multimodal input devices (e.g., one or more microphones, imaging devices and/or sensors). In some implementations, operation 430 may be performed by one or more hardware processors configured by computer-readable instructions including a performance analyzer module 525, in accordance with one or more implementations.

In some implementations, the robot computing device may then determine a reading level of the user based on the captured parameters and measurements and/or analyzation thereof. In some implementations, in operation 432, the robot computing device and/or performance analyzer module may calculate a reading level of user based on parameters and measurements captured by one or more input devices as well as characteristics of book being read. In some implementations, for example, the robot computing device and/or performance analyzer module may assess or calculate the reading level based on, but not limited to clarity of reading, speed of reading, fluency, reading comprehension and/or vocabulary of books. The reading operations described herein are interactive and may be continuous until the user completes reading the book or reading the article. In some implementations, operation 432 may be performed by one or more hardware processors configured by computer-readable instructions including a performance analyzer module 525, a book tracking system module 515, a reading support system module 530 and/or a story processor module 535, in accordance with one or more implementations. In some implementations, the flowchart illustrated in FIG. 4B will continue in a loop from operation 418 until operation 432 until the user has stopped reading the reading of the article or book, in accordance with one or more implementations.

In some implementations, after a user is done reading a book, in operation 434, a performance analyzer module of the robot computing device may generate a user performance report based on captured parameters and measurements and determined reading level and may communicate the report to interested parties such as parents, guardians, therapists, and/or the child (in some circumstances), and/or the computing devices associated with the parents, guardians, therapists, and/or children (in some circumstances), in accordance with one or more implementations. In some implementations, operation 434 may be performed by one or more hardware processors configured by computer-readable instructions including a performance analyzer module 525, in accordance with one or more implementations.

FIG. 4C illustrates on-the-fly processing of non-processed reading articles and utilization of the multimodal book reading system according to some implementations. In some implementations, an operation 436 may include capturing a title or image of a cover of a reading article and/or text of two or more pages of a reading article while a user is reading the reading article to identify the title of the reading article and begin to start capturing the contents of the reading article. Since this is processing the reading article on-the-fly, analyzing the book reading and providing an interactive reading experience all around the same time, FIG. 4C includes elements of FIG. 4A and FIG. 4B and thus details may not be repeated here. In some implementations, an operation 438 may include capturing measurements or parameters of the user's reading of the reading article by following the user's reading of the reading articles.

In some implementations, an operation 440 may include analyzing the generated text to identify characteristics of the reading article, including genre, plot, mood, and/or characters in the reading article. In some implementations, an operation 442 may include storing identified characteristics in a book database. In some implementations, an operation 444 may include generating augmented content files for one or more portions of reading article based at least in part on identified characteristics, and where a user is in a reading article or book.

In some implementations, an operation 446 may include storing augmented content files in book database and associating augmented content files with different portions of reading article. In some implementations, an operation 448 may include determining a user's progression in reading of the reading article by reviewing the captured measurements and/or parameters from the one or more input devices. In some implementations, an operation 450 may include retrieving augmented content files from an asset database 540 based on captured measurements and parameters and user's progression in reading the reading article. In some implementations, an operation 452 may include transmitting the augmented content files to the one or more multimodal output devices. In some implementations, because this is an ongoing interactive experience, the flowchart will continuously loop back to step 436 as the user continues to read until the user is finished reading the book and an entirety of the reading article may then be captured and/or categorized for the user. In the embodiment described in FIG. 4C, the operations 436-452 may be performed by one or more hardware processors executing computer-readable instructions the software and/or hardware modules described in FIG. 5A

FIG. 5A illustrates different subsystems and/or modules of a multimodal interactive book reading system in accordance with some implementations. In some implementations, the multimodal interactive book reading system may include an asset database 540, a book recommender module 545, an existing book database 550, a story processor module 535, a reading support system module 530, a performance analyzer module 525, a performance reporting system 520, a book recognizer module 515, a book tracking system or module 515 and/or a multimodal output system 510. In some implementations, certain portions of the multimodal interactive book system 500 may communicate and/or interact with the user 505. In some implementations, the asset database 540 may include augmented content (e.g., sound files, visual effect files, motor movement files, graphics files) that is associated with a number of books, the contents of which are stored in the book database 550. In some implementations, the augmented content may be linked to specific portions of the books or to times during the reading of the book where the augmented content may be utilized. In some implementations, the book database 550 may include copies of text of the books, images of the books and/or other content extracted from the books. In some implementations, the book database 550 may include characteristics of the books stored therein (e.g., genre, characters, reading level, vocabulary level, plot, etc.). In some implementations, the book database 550 may capture the text of the book through Optical Character Recognition (OCR) or through third-parties providing this information through data transfer. Similarly, the book database may capture images of the books (including but not limited to covers) by scanning the cover (either in real-time or during a preprocessing step) and/or by receiving images from third-parties who have already captured the book. In some implementations, a book recommender module 545 may receive inputs from a user or from other subsystems of modules of the multimodal interactive book reading system and based at least in part on the inputs, may recommend one or more books for a user. In some implementations, a book recommender module 545 may receive augmented content or assets and/or recommendations from other users of the multimodal book reading system. In some implementations, a book recommender module 545 may also learn interests of different users and provide recommendations of books or reading articles based on common interests among users. In some implementations, for example, a system may receive as an input that the user would like to read an adventure book or a comedy book. In this example, the book recommender module 545 may receive this input and recommend a book in that category or genre.

In some implementations, a book tracking system or book tracking module 515 may receive inputs from the multimodal input system and identify where in the book the user may be at a current time. In some implementations, for example, a book tracking system 515 may receive the user's voice (who is reading the book) from the one or more microphones, perform voice recognition on received user's voice to convert the user's voice to text and then to compare the converted text to processed portions of the books that are stored in the book database in order to determine a location in the book the user is. In some implementations, the book tracking system 515 may provide the location identifier or parameter to the story processor module 535 in order for the story processor module 535 to link the augmented content from the asset database 540 for that identified location parameter or location identifier. In some implementations, for example, if there is a cow mentioned in the book on page 3, the book tracking system 515 may identify the reader is on page 3 after hearing the user's voice, may communicate this location identifier to the story processor module 535 which may retrieve a “mooing” sound file and/or a cow image. In this illustrative example, the story processor module 535 may then communicate the “mooing” sound file and/or the cow image to the multimodal output system 510 (e.g., specifically the display of the robot computing device or digital companion and/or the speakers of the robot computing device or digital companion). In some embodiments, in another example, the book tracking system 515 may receive as an input, an image of a page of the book or a portion of the book including a page number. In some implementations, in this illustrative example, the book tracking system 515 may analyze the received image and determine the page that the user is on and may communicate this information to the story processor module 535 to be utilized as described above. In some implementations, the page number the user is on as well as a timeframe the user has been reading the book may be communicated to a performance analyzer module 525 which may calculate a reading speed of a user (and some of this information may be utilized to assist in calculating a reading comprehension level of a user).

In some implementations, a book recognizer module 518 may be able to identify what book a user is reading. In some implementations, the user may speak the name of the book, the one or more microphones of the robot computing device may receive the spoken name and the robot computing device may process the spoken name, convert it to text and the book recognizer module may compare the converted text to existing book titles that have processed or preprocessed by the robot computing device. In some implementations, the book recognizer module 518 may then either identify that the book is recognized or is a book that has not yet been processed. In some implementations, the book recognizer module 518 may receive input that a user has selected via a menu on a computing device (e.g., a book the user or the parent/guardian has selected via, for example, the companion application). In some implementations, the book recognizer module 518 may scan a front cover of a book via the one or more imaging devices of the robot computing device, compare the images and/or text of the title of the book to prestored book titles and/or images, and then identify the book is one of the books that has been already processed and/or identified by the robot computing device system or systems interfacing with the robot computing device system. In some implementations, the book recognizer module 518 may scan pages of the book the user has selected, compare the scanned pages of the user's book with text from books that have already been processed by the multimodal books reading system and may identify if the book that the user has already been processed by the system. In some implementations, the book the user has may include an RFID chip or transmitter including book identifier parameters. In some implementations, the book recognizer 518 may utilize an RFID reader of the robot computing device or digital companion to capture the book identifier parameters stored on the RFID chip, compared the captured book identifier parameters to existing processed books in order to identify if the user's book has been processed and is available for use in the multimodal book reading system.

In some implementations, a performance analyzer module 525 may review a user's reading abilities by receiving input from the book tracking system and calculating statistics based on how quick a book is being read, whether or not the words are being pronounced correctly, whether or not a user appears to be understanding the concepts or details of the book being read. In some implementations, a performance analyzer module 525 may communicate with a book recommender module 545 and/or book database to obtain existing parameters or measurements reading the book. In some implementations, these existing parameters or measurements may identify the vocabulary level of the book, how long it takes an average reader to read the book, etc. In some implementations, the performance analyzer module 525 may communicate a user's statistics and performance measurements to the performance reporting system 520. In some implementations, the performance reporting system 520 may communicate with a companion application and/or a parent's software application.

In some implementations, the reading support system 530 may be a broker or analyzing module in the multimodal book reading system 500. In some implementations, the reading support system 530 may receive performance analytics and/or measurements from the performance analyzer module 525, may receive book recommender responses from the book recommender module 545 and/or may receive information and/or details about the book from the book database 550. In some implementations, the reading support system or module 530 may then determine whether or not to change the reading experience of the user. In some implementations, the reading support system or module 530 may determine that the user is reading the book too fast and may desire to determine if the user is comprehending the book. In some implementations, the reading support system or module 530 may generate a list of questions that can be sent to the story processor module 535 and then to the user via the multimodal output system. The response to the questions may be evaluated by the multimodal book reading system in order to quantify the user's understanding of the text being read and potentially provide additional guidance to the user on ways to enhance the corresponding reading-comprehension skills. In some implementations, the reading support system 530 may also determine, based on input from the book tracking system 515, where the reader is and may provide recommendations to the story processor 535 of what augmented content from the asset database 540 should be displayed or reproduced for the user. In addition, the reading support system 530 may recommend what movements of the robot computing device may be implemented based on the user's location in the book. In some implementations, the story processor 535 may make the determination of how to integrate content recommended by the reading support system 530 and housed or located in the asset database 540 into ongoing or current conversations and/or interactions with the user. In some implementations, the story processor module 530 may also receive input from the book tracking system 515 in order to determine where the user is in the book and whether there may be natural breaking points and/or changes in the story where the augmented content or other information may be more easily integrated. In some implementations, the story processor module 535 may communicate the retrieved files from the asset database 540 to the multimodal output system 510 in order to interact with the user.

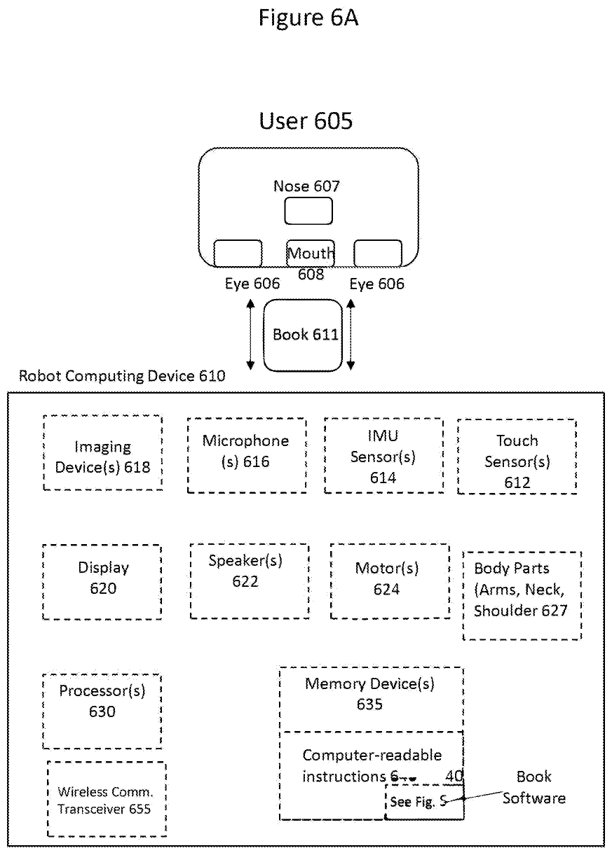

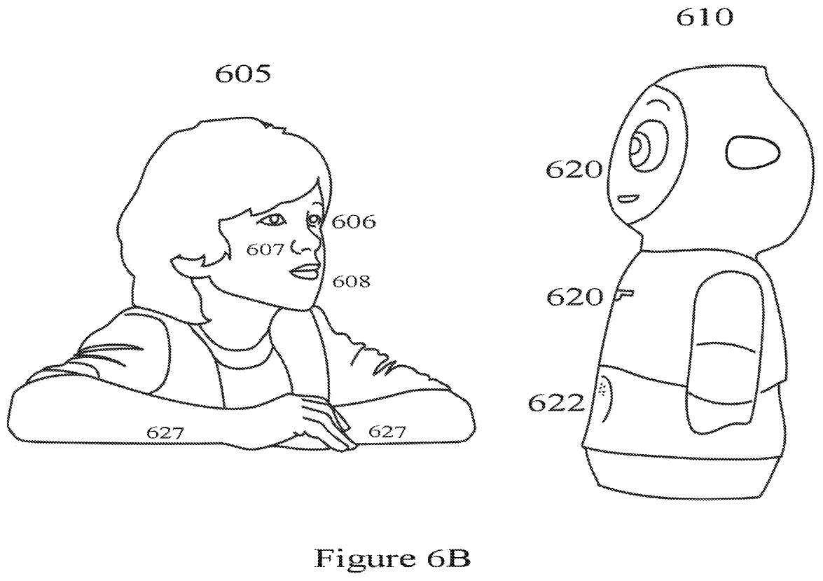

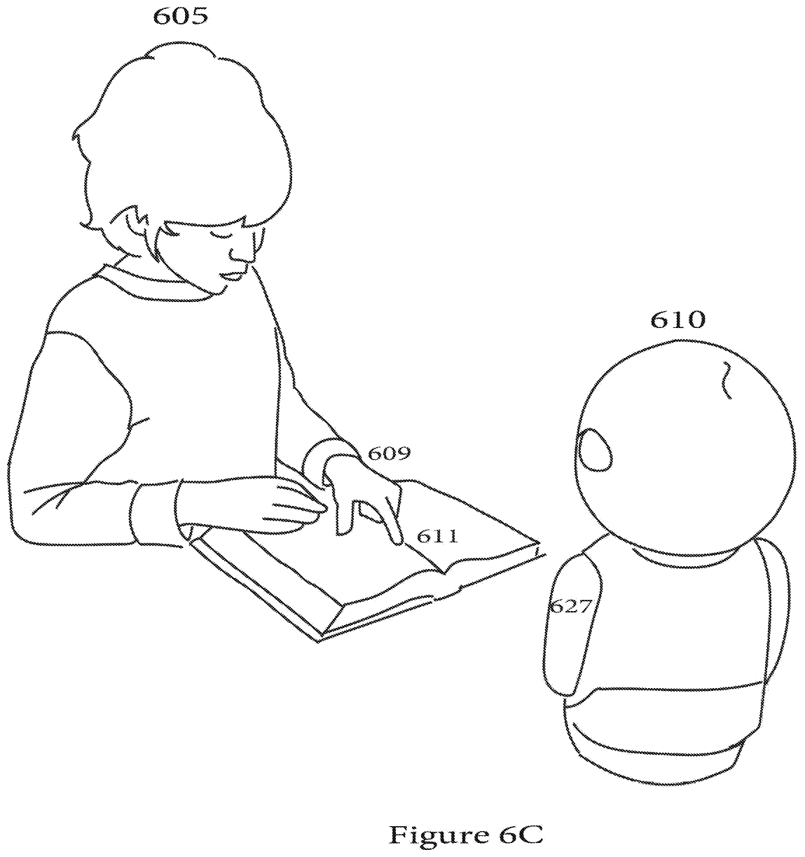

FIG. 6A illustrates communication between a user or a consumer and a robot computing device (or digital companion) according to some embodiments. FIG. 6B illustrates a user 605 communicating with a robot computing device 610. FIG. 6C illustrates a user 605 reading a book 611 with the robot computing device 610. In some embodiments, a user 605 may communicate with the robot computing device 610 and the robot computing device 610 may communicate back to the user 605 thereby creating a conversation interaction. In some embodiments, the user 605 may be reading a book 611 and the robot computing device 610 may be interacting with the user 605 while the user is reading the book 611. In some embodiments, multiple users may communicate with robot computing device 610 at one time, but for simplicity only one user is shown in FIG. 6A. In some embodiments, the user 605 may have facial features that the robot computing device 610 may analyze images of (e.g., such as a nose 607, one or more eyes 606 and/or a mouth 608). In some embodiments, the user may speak utilizing the mouth 608 and make facial expressions utilizing the nose 607, the one or more eyes 606 and/or the mouth 608. In some embodiments, the user 605 may speak and make audible sounds via the user's mouth. In some embodiments, the robot computing device 610 may include one or more imaging devices (cameras) 618, one or more microphones 616, one or more inertial motion sensors 614, the one or more touch sensors 612, one or more displays 620, one or more speakers 622, one or more wireless communication transceivers 655, one or more motors 624, one or more processors 630, one or more memory devices 635, and/or computer-readable instructions 640. In some embodiments, the computer-readable instructions 640 may include the systems and modules described in FIG. 5 (modules 530, 535, 525, 545, 515, 518, and 520) which may handle and be responsible for the book reading activities and communications with the user. In some embodiments, the one or more wireless communication transceivers 555 of the robot computing device 510 may communicate with other robot computing devices, a mobile communication device running a parent software application and/or various cloud-based computing devices. There are other modules that are part of the computer-readable instructions. In some embodiment, the computer-readable instructions may by stored in the one or more memory devices 535 and may be executable by the one or more processors 530 in order to perform the functions of the reading-based modules described in FIG. 5, as well as other functions of the robot computing device 510. The features and functions described in FIGS. 1A and 1C also apply to FIG. 6A, but are not repeated here.

In some embodiments, the imaging device(s) 618 may capture images of the environment around the robot computing device 610 including images of the user and/or facial expressions of the user 565. In some embodiments, the microphones 616 may capture sounds from the one or more users. In some embodiments, the inertial motion unit (IMU) sensors 614 may capture measurements and/or parameters of movements of the robot computing device 610. In some embodiments, the one or more touch sensors 612 may capture measurements when a user touches the robot computing device 610 and/or the display 620 may display facial expressions and/or visual effects for the robot computing device 610. In some embodiments, the one or more speaker(s) 622 may play or reproduce audio files and play the sounds (which may include the robot computing device speaking and/or playing music for the users). In some embodiments, the one or more motors 624 may receive instructions, commands or messages from the one or more processors 630 to move body parts or sections of the robot computing device 610 (including, but not limited to the arms, neck, shoulder or other appendages.). In some embodiments, the one or more motors 624 may receive messages, instructions and/or commands via one or more motor controllers.

FIG. 6C illustrates a child consumer reading a book (or other reading article) with a robot computing device according to some embodiments. In many interactions, the user 605 may be facing the robot computing device 610 as is illustrated in FIG. 6B. The robot computing device 610 may include one or more display(s) 620 and/or one or more speakers 622. The one or more display(s) may include one or more LED bars and/or lights. The user 605 may include eyes 606, a nose 607 and/or a mouth 608. When the user 605 is reading a reading article (e.g., book) the book 609 may be placed in front of the user 605 and the user's hands and/or fingers 609 may be pointing to words or pictures in the book 611. In this embodiment, the robot computing device 610 may be able to capture images of both the book 611 and/or user 605 in order to enhance the user's book reading experience and/or to calculate the user's reading performance statistics. Although a book 611 is specified here, the techniques described herein apply to other reading articles. In some embodiments, the child user 605 may be facing the robot computing device 610 and in other embodiments, the child user 605 may be sitting next to the robot computing device 610. In these embodiments, it may be preferrable for an imaging device (or imaging devices) 618 to be able to view and/or be able to have the book in view of the imaging device (or imaging devices) 618. This allows the robot computing device to be able to see, view and capture images of different parts of the book.

In some embodiments, the child user 605 may decide to read a book, but may not have decided which book to read. In some embodiments, the child may state “I would like to read a book,” and the robot computing device 610 may receive the one or more associated sound files via the one or more microphones 616, may analyze the received one or more sound files after they are converted to text, may generate responsive sound files, and may respond to the child user by stating “What type of book would you like to read.” In response, the child user 605 may respond with a type or genre of book (adventure or scary book, comedy or fun book, or biography or book about a person), or a book subject (e.g., giraffes, space, or beaches). In these embodiments, the robot computing device 610 may receive the user's responsive sound files via the one or more microphones 616, convert the responsive sound files to one or more text files, analyze the one or more text files to determine the genre (or type) of book or the subject of the book. In these embodiments, the book recommender module 545 may receive one or more text files and communicate with the book database 550 to determine book options that are available to be presented to the user. In these embodiments, the book database 550 may communicate the books that are available to the book recommender module 545, which may generate one or more sound files corresponding to the selected book titles and may communicate these sound files to the one or more speakers 622 in the multimodal output system 510 to present one or more book titles to the user 505. In some embodiments, there may be only one book title if only one book meets the selected type or subject. In some embodiments, the book recommender module 545 may consider the user's past reading selections in considering what books to recommend. In some embodiments, the book recommender 545 may utilize the user's reading characteristics or measurements when recommending book titles (e.g., the user may be a beginning reader, there may be three book titles which meet the selected type or subject (with one being for intermediate readers and two being for beginning readers), and the book recommender module 545 may recommend only the two book titles for beginning readers). In these embodiments, the child user 605 may then respond by selecting one of the book titles (which may be referred to as Book A) “Lets read Book A”. In these embodiments, the robot computing device 610 receives the book selection voice files, converts these files to text and book selection text files may be communicated to the book recommender module 545, which loads the necessary information regarding the selected book into the one or more memory devices 635 of the robot computing device 610 so that the robot computing device 610 can augment the reading of the book by the user. In some embodiments, the selection of the book may take a couple of interaction rounds between the child user 605 and/or the robot computing device 610 before a final selection is made. The user 605 then picks the book and begins to read the selected book 611, as is illustrated in FIG. 6C. In other embodiments, the user 605 may just select a book 611 to begin reading. In some embodiments, the user may select a book 611 that the robot computing device 610 has parameters and information for, as well as augmented content. In some embodiments, the user may select a book 611 that the robot computing device 610 has not processed for and the robot computing device may process the book 611 as the user is reading it, as described in FIG. 4A.

In some embodiments, the child user 605 may start reading the selected book 611. In some embodiments, the robot computing device 610 may utilize the multimodal input system or devices (e.g., imaging devices 618, microphones 616, or sensors 612 and 614) to monitor and capture user reading characteristics and/or measurements. In these embodiments, the one or more microphones 616 of the robot computing device 610 may record or capture one or more sound files of the user reading and convert the user's one or more reading sound files to one or more reading text files. In these embodiments, the one or more reading text files are utilized in many ways by the robot computing device 610 in order to enhance the user's experience and/or improve the user's reading skills. In some embodiments, the story processor module 535 may communicate the one or more reading text files to the book tracking system or module 515 in order to determine a location in the selected book where the user is currently reading. In these embodiments, the book tracking system 515 may communicate an identified book location to the story processor module 535 which may in turn communicate with the asset database 540 to retrieve augmented content 540 related to the location in the book 611 where the user 605 is reading. In this embodiment, for example, the user 605 may be reading about a story and that part of the story may be about dogs, and the story processor module 535 may retrieve barking sound files from the asset database 540 and play the barking sound files on the one or more speakers 622. Similarly, the story processor module 535 may retrieve dog animation and/or video files from the asset database 540 and/or may play these retrieved dog animation images and/or video files on the display device 620 of the robot computing device 610. This is meant to help the user enjoy the book reading experience. In some embodiments, the robot computing device 610 may also analyze whether the user enjoys the augmented content. More specifically, the multimodal input devices (612, 615, 616, and/or 618) of the robot computing device may capture sounds or words that the user may speak (via the one or more microphones 616) and/or expressions or body movements (via an imaging devices 616 or sensors 612 or 614) in response to the playing or displaying of the augmented contact. For example, if the user frowns when hearing the played sound files (barking) or shakes her head side to side when viewing the dog animation, the robot computing device 610 may capture these sound files and/or images and the story processor module 535 in conjunction with the performance analyzer 525 may identify that the augmented content was not well received by this user and may store this augmented content likeability parameter for future use. This enhances the success of the multimodal book reading system because it helps identify what augmented content is enhancing the reading experience and what augmented content is not enhancing the user's reading experience.

In these embodiments, the child user 605 may continue reading the selected book 611 and the robot computing device 610 may continue monitoring or watching the child's reading of the selected book 611 and generating augmented content for different portions of the selected book 611. In these embodiments, the child may be reading the selected book and may speak “the doggie is leaving.” In these embodiments, the robot computing device 610 may capture the spoken words, convert them to text and analyze the spoken text to determine where the user is within the book. Based on the analysis of the received text files by the book tracking system 515, the story processor module 535 may retrieve action commands from the asset database 540 to instruct the robot computing device 610 to wave and to speak the phrase “bye-bye doggie”. In these embodiments, the story processor module 535 may communicate commands to the motor controller and motor 624 for the robot computing device's arm and hand 627 to wave to the user 605 and/or to communicate one or more sound files to cause the speaker(s) 622 to play “bye-bye doggie.” In some embodiments, the robot computing device 610 may utilize its multimodal input devices (e.g., one or more microphones 616 and/or imaging devices 618) to determine the user's reaction to the generated augmented content. In some embodiments, based on analysis of the user's reaction (e.g., capture and analysis of facial expressions and/or body language and/or capture and analysis of sound files) and may store a likeability parameter for the augmented content, as is described above.

In some embodiments, the robot computing device 610 may anticipate things happening in the selected book 611 by knowing where the user is reading and knowing that another action is soon forthcoming. In these embodiments, the robot computing device 610 may capture the child user 605 speaking words and/or phrases from the book that “I am going to see what is happening ahead of me.” The robot computing device 610 may utilize the one or more microphones 616 to capture the sound files, convert the sound files to text files and/or to analyze the text files. In these embodiments, the book tracking system 515 may determine a location in the book where the user is reading, and provide the location or location parameter to the story processor module 535, which may determine a next action in the book 611. In this embodiment, for example, a next action in the book may be that the character in the book is approaching a crowd and the user will be startled by a loud noise. In this illustrative example, the story processor module 535 may determine augmented content regarding the events that are about to happen in the book 611 and may retrieve the corresponding augmented content from the assert database 540. For example, the story processor module 535 may produce commands or instructions along with markup files that cause eyes on the display 620 of the robot computing device 610 to get big and to retrieve sound files of crowd noise including a loud crashing noise halfway through the retrieved sound files. In this illustrative example, the story processor module 535 may communicate the instructions and/or commands and markup files to the display 620 of the multimodal output system 510 to cause the robot computing device to open their eyes wide in a startled manner and the one or more speakers 622 to emit loud crowd noise including a loud crashing noise. In this illustrative example, the robot computing device 610 may also capture the user's reactions and determine a likeability or success parameter or measurement for the generated augmented content, as is discussed above.

In some embodiments, when the user is reading, the user may not be speaking the words out loud. In some embodiments, the robot computing device 610 may instead utilize the one or more imaging devices 618 to capture images of the pages of the selected book 611 while the user 605 is reading the selected book 611. In these embodiments, the robot computing device 610 may analyze the one or more captured images and/or the book tracking module 515 and/or the book recognizer module 518 may determine where in the book the user or consumer is based on the captured and/or analyzed image. In these embodiments, the book tracking module 515 and/or the book recognizer module 518 may communicate a location or location parameter to the store processor module 535. In these embodiments, the story processor module 535 may utilize the location or location parameter to identify augmented content associated with the identified location and/or location parameter from the asset database 540. In these embodiments, the story processor module may retrieve the augmented content associate with the location or location parameter and may transmit the augmented content to the multimodal output system 510 which plays and/or displays the augmented content to the user. For example, the book tracking module 518 and/or book recognizer module 518 may determine the user is at a location in the book 611 where someone is sleeping, may communicate this location or parameter to the story processor module 535, which may in turn retrieve augmented content in the form of instructions or commands to cause the robot's eyes in a facial expression to close and/or the robot speakers to emit a snoring sound and/or a “shhhhh” sound. In these embodiments, the story processor module 535 may communicate these retrieved instructions and/or commands to the multimodal output system 510 to cause the speakers to make the identified sounds and the monitor 620 to display the identified facial expressions. In other similar embodiments, the augmented content may be a video showing a pillow and/or a person sleeping in order to mimic the location in the selected book 611. In these embodiments, the user's liking of the augmented content may also be analyzed, as is discussed in detail above.

In some embodiments, the robot computing device 610 may also analyze the user's reading characteristics and/or performance with the selected book 611 while the child user 605 is reading the book. In some embodiments, the user may be reading the book 611 and the multimodal input devices may capture one or more sound files of the user reading the selected book out loud and/or also images of the user reading the book 611. In some embodiments, the one or more imaging devices 618 may capture pages of the book as the book is being read and the book tracking module 515 may analyze the captured page images to determine where in the book 611 the user is currently at. In these embodiments, the book tracking module 515 may identify page numbers from the image, illustrations from the image and/or words from the image and compare these to known or existing numbers, illustrations and/or words to identify a location in the book 611. In some embodiments, the imaging devices 618 of the robot computing device 610 may also capture images of the user 605. In some embodiments, the images of the user may be received and/or analyzed by the story processor module 535 and/or the reading support system 530 to determine if there are any visual cues that may be utilized to assist in calculating user's reading characteristics. For example, the reading support system may analyze the images and identify that the user is furrowing their eyebrow, frowning and/or may have their hands in the air (in a frustrated manner). In this embodiment, the reading support system may then identify that the user is becoming frustrated in reading the book and utilize this to take next steps in interacting with the user.

Similarly, the book tracking module 515 may receive one or more text files and/or associated sound files generated by the user and may analyze these text files to extract words or phrases from the sound files and to compare these to know words or phrases for the selected book. In these embodiments, the book tracking module 515 may also interface with a timer module that identifies how long the user has been reading the book. In these embodiments, the timer module may start to keep track of when the user starts reading the book by the book tracking system 515 determines via the image that the user is reading the book (e.g., the user's lips are moving or the user is pointing at words in the book) and/or via the captured sound files (e.g., the user begins to speak a word). In these embodiments, the book tracking module 515 may determine locations in the selected books and associated time measurements and/or parameters multiple times as the user is reading the selected book. This may continue until the user is done reading the book. In some embodiments, the book tracking module 515 may then communicate the captured sound files, the one or more received text files, a plurality of timer measurements or parameters, and the locations in the book for the user corresponding to the timer measurement or parameters to the performance analyzer module 525. In some embodiments, the communication of this information may occur during reading of the book by the user or may occur after reading of the book by the user. In response to receiving this information, the performance analyzer module 525 may then utilize this information to calculate and/or generate user reading performance measurements or parameters. In some embodiments, the performance measurements or parameters may include user reading speed, how long the user is reading the book, reading comprehension, and/or reader pronunciation accuracy, as well as how long the reader took to complete the book. In some embodiments, the performance analyzer module 525 may compare the generated performance measurements or parameters to known third-party reading performance parameters and/or prior user reading performance parameters.

The robot computing device may also utilize the user's reading performance parameters to assist the user in improving and/or enhancing the user's reading experience. For example, if the robot computing device 610 knows this is a first time the user is reading the selected book 611 and the performance analyzer module determines that the user, is reading at a fast rate, the reading support system module 530 may determine that that the user should be tested to verify the user is understanding the selected book 611. In these examples, the reading support system 530 may request and/or receive a list of questions to ask the user about the selected book to see if the user is understanding the book. In these embodiments, the reading support system may transfer the list of questions to the story processor module 535, which then may forward the questions to the one or more speakers 622 of the multimodal output system 510 to speak the questions from the user. In these examples, the user may speak the answers, the one or more microphones 616 may capture the sound files with the user's answers, the one or more answer sound files may be converted to one or more answer text files by the robot and the one or more answer text files may be communicated to the reading support system 530. In these embodiments, the reading support system 530 may compare the answers to known answers that are provided by the book recommender module and book database 550. In these embodiments, the reading support system 530 may then provide the comparison results to the performance analyzer module 530 for later sharing with the user or the user's parents. In other embodiments, if the reading support system 530 determines that the user is reading to fast, the reading support system 530 may communicate instructions or commands and/or sound files to the story processor module 535 and then to the one or more speakers 622 of the multimodal output system 510 who play the words “Please slow down, you are reading too fast” to the user in order to slow the user down. In some embodiments, the reading support system 530 may receive the user performance parameters and identify that the user is mispronouncing certain words. In these embodiments, the reading support system 530 may identify this in the user performance parameters or measurements, which may be shared with the user's parent. In some embodiments, the reading support system 530 may also communicate with the story processor module 535 to communicate with the user through the multimodal output system 510 that this word (and other words) being mispronounced. In these embodiments, the reading support system 530 may communicate with the book tracking system 515 to determine when the word or phrase Is going to be spoken. Based on this information, the reading support system 530 and/or the story processor 535 may determine when to interrupt the user's reading of the book 611 to let the user know how to properly pronounce the mispronounced words or phrases. In some embodiments, the reading support system 530 may also determine, after the user is done reading the selected book 611, to test the user on the content and characteristics of the book 611. In this embodiment, the reading support system 530 may retrieve a list of questions for the selected book (e.g., the whole book) and may communicate these questions to the story processor module 535 through the multimodal output system 510 speakers 622 to the user. As discussed above, the user will speak or write the answers, the multimodal input device will capture the answers and then provide the answers to the reading support module 530 which will determine if the answers are correct and/or provide this comparison to the performance analyzer module 525.

In some embodiments, the user's parent may want to determine how the user is performing with respect to book reading. In these embodiments, the performance analyzer module 525 may communicate the user's reading performance parameters and/or measurements to the performance report system 520. In these embodiments, the performance report system 520 may communicate the user's reading performance statistics to a parent software application, which may display the results of the user's reading performance. In some embodiments, the performance report system 520 may calculate aggregated reading parameters and/or measurements based on the user's past reading performance and the current reading performance. In some embodiments, the performance report system 520 may receive the readers performance statistics and calculate a new performance reading parameter based on the input received from the performance analyzer. For example, in this embodiment, the performance report system 520 may receive scores from any tests the user took, a percentage of words pronounced correctly and/or other visual information and may calculate a user's reading comprehension score based at least in part on these parameters. In some embodiments, the performance report system 520 may communicate the report to an external computing device and specifically a parent or guardian software application on a parent's mobile communication device. In this embodiment, the parent or guardian may then review the user's reading performance statistics and/or see if the user is meeting preset goals.

In some embodiments, the user may be reading a book that is not pre-scanned and/or not known to the robot. However, the robot computing device may still be able to assist the user in reading the book, providing augmented content, assist in creating a positive reading experience and/or helping a parent or guardian understand if the user is comprehending the book that the user is reading. Referring to FIG. 5, the multimodal book reading system 500 may also include a natural language processing module 595 and/or a multimodal input module or system 590. In these embodiments, when the user is reading an unknown book, the one or more microphones of the multimodal input module 590 may capture the user's voice when the user is reading the unknown book and create voice files. The multimodal input module 590 and/or the natural language processing module 595 may convert the user's voice files to text files and the natural language processing module 595 may analyze to user's text files to generate or extract book parameters and/or characteristics of the book the user is reading (e.g., what characters are in the book, what is the mood or tone of the book, what is a reading level of the book, what is the genre of the book, etc.). In these embodiments, the natural language processing module 530 may communicate these extracted book parameters and/or characteristics and may communicate these extracted book parameters and/or characteristics to the book tracking system 515 and/or the story processor module 535. In these embodiments, the story processor module 535 may analyze the extracted book parameters and/or characteristics and may extract or retrieve augmented content from the asset database 540 to enhance the user's reading of the book, based at least in part on the extracted book parameters and/or characteristics. This may be by having the story processor module 535 communicate with the multimodal output module 590 to set the right ambient for the unknown book based on the extracted book parameters and/or characteristics. In these embodiments, the story processor module 535 may also generate questions regarding the subject matter of the book, based on the extracted book parameters and/or characteristics. In these embodiments, the generated book questions may be communicated to the multimedia output system 590 to be played to the user. In these embodiments, the user may speak answers to the questions and the multimodal book reading system (e.g., the multimodal input module 590, the natural language processing module 595) may process the response voice files, covert the response voice files to response text files, and the performance analyzer module 525 may determine whether the user provided and the right answer to the questions from the book (which may help in determining whether a user is comprehending and/or understanding the book. In some embodiments, the natural language processing module 595 may also communicate the user's text files to the performance analyzer module 525 to determine a user's performance measurements or values for the user's reading of the unknown book. These performance measurements may include reading speed, reading comprehension, speaking quality, etc.

In some embodiments, the multimodal output system 510 may also analyze the images of the unknown book. In these embodiments, when the user is reading an unknown book, the one or more imaging devices of the multimodal input module 590 may capture images of illustrations in the book. In these embodiments, the captured images may be analyzed by the book recognizer module 518 to identify if the captured images include similar subject matter to subject matter of the books in the book database 550 and/or to augmented content in the asset database 540. As an example, if there is an illustration of a horse in the book and thus in the captured image, the book recognizer module 518 may communicate this information to reading support system 530 and/or the story processor 535. The story processor module 535 may then retrieve horse-related augmented content files from the asset database 540 which may be utilized (as described above) to enhance the user's reading experience.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination. As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method to process reading articles utilizing a robot computing device, comprising:
accessing computer-readable instructions from one or more memory devices for execution by one or more processors of the robot computing device;
executing the computer-readable instructions accessed from the one or more memory devices by the one or more processors of the robot computing device; and
wherein executing the computer-readable instructions further comprising:
identifying a title of one or more reading articles;
storing the one or more reading article titles in a book database;
scanning two or more pages of the one or more reading articles and generating text files representing content of the one or more reading article;
analyzing the generated text files for the one or more reading articles to identify characteristics of the one or more reading articles, the identified characteristics of the one or more reading articles including genre, plot, mood, or one or more characters of the one or more reading articles;
storing the identified characteristics of the one or more reading articles in the database and associating the identified characteristics with the one or more reading article titles;
generating augmented content files for one or more portions of the one or more reading articles based at least in part on the identified characteristics, and
storing the augmented content files in the database and associating the augmented content files with the one or more portions of the one or more reading articles.

2. The method of claim 1, wherein the augmented content files include questions relating to the one or more reading articles.

3. The method of claim 1, the characteristics of the one or more reading articles further including pacing of the one or more reading articles.

4. The method of claim 1, the characteristics of the one or more reading articles further including scenes, keywords, and concepts present in the one or more reading articles.

5. The method claim 1, wherein executing the computer-readable instructions further comprising:
selecting a reading article for reading by a user;
capturing measurements and/or parameters of the user's reading of the selected reading article by following the user's reading from one or more input devices;
determining a user's progression of the user's reading of the selected reading article by reviewing the captured measurements and/or parameters from the one or more input devices;
retrieving augmented content files from an asset database, the retrieval of the augmented content files based at least in part on the captured measurements and/or parameters and the user's progression in reading the selected reading article; and
transmitting the one or more augmented content files to at least one of the one or more multimodal output devices for presentation by the robot computing device to the user.

6. The method of claim 5, wherein selecting the reading article for reading by the user further comprises: a) requesting the selected reading article by capturing verbal commands via a microphone of the robot computing device; b) touching the selected reading article the user would like to read and having the input device capture the touching of the selected reading article; c) gesturing or pointing to the selected reading article and having the imaging device capturing the gesturing or pointing; or d) utilizing an input from mouse or keyboard to determine selection of the selected reading article.

7. The method of claim 5, wherein selecting the reading article for reading by the user further comprises: a) analyzing a user's description to determine an appropriate reading article; b) analyzing past reading articles that the use enjoyed to determine an appropriate reading article; c) analyzing a user's reading ability to determine an appropriate reading article; or d) determining via an algorithm whether a book is being advertised as an appropriate reading article

8. The method of claim 5, wherein the one or more input devices include one or more RFID readers to obtain information from the one or more RFID chips in the selected reading article, one or more imaging devices to capture text and/or images from the selected reading article and/or one or more microphones to capture a user's voice in reading the selected reading article and generating audio files based on the user's reading.

9. The method of claim 5, wherein the augmented content files comprise audio files for speech to provide audible feedback to the user, mobility commands for the robot computing device to cause the robot computing device components to move, commands or instructions to be sent to the display for visual feedback to the user; or music files to be reproduced by one or more speakers, wherein the audio files may be music files or audible sounds such as laughs or sighs.

10. (canceled)

11. The method of claim 9, wherein the visual feedback may be instructions to cause a monitor to display different facial expressions or visual reactions and/or one or more light emitting diodes (LEDs) or light bars to display light patterns and wherein the mobility instructions may be instructions or commands to cause a head of the robot computing device to move, the appendages of the robot computing device to gesture or move, and/or the robot computing device to move.

12. (canceled)

13. The method of claim 5, wherein executing the computer-readable instructions further comprising generating an audio file and transmitting the audio file to a speaker of the robot computing device, the audio file representing a question or comments to be audibly played to the user via the one or more speakers of the robot computing device to request a response from the user.

14. The method of claim 13, wherein executing the computer-readable instructions further comprising receiving a verbal response from the user as a response audio file at one or more microphones to create an interactive experience with the robot computing device; analyzing the response audio file, by the robot computing device, to determine a level of reading comprehension level of the reader; and calculating a reading level of the user based on the determined reading comprehensive level of the reader; based on characteristics of the selected reading article being read, and the characteristics including vocabulary of the selected reading article.

15. (canceled)

16. (cancelled)

17. (canceled)

18. The method of claim 5, wherein executing the computer-readable instructions further comprising calculating the reading level of a user based on the parameters and measurements captured by the one or more input devices as well as characteristics of the selected article being read and the parameters and measurements captured by the one or more input devices are a) clarity of reading of the selected reading article determined by capturing, via one or more microphones audio files of the user reading the selected reading article and analyzing the audio files; b) speed of reading of the selected reading article determined by capturing, via one or more microphones audio files of the user reading the selected reading article and analyzing the audio files; or c) fluency of reading of the selected reading article determined by capturing, via one or more microphones audio files of the user reading the selected reading article and analyzing the audio files to determine if the user is correctly pronouncing the words of the selected reading article.

19. The method of claim 18, wherein executing the computer-readable instructions further comprising generating a report based at least in part on the captured parameters and measurements captured by the input devices, the characteristics of the reading article and/or the determined reading comprehension.

20. A method of processing a reading article for interactive multimodal reading as a child is reading a reading article, comprising:
accessing computer-readable instructions from one or more memory devices for execution by one or more processors of the robot computing device;
executing the computer-readable instructions accessed from the one or more memory devices by the one or more processors of the robot computing device; and
wherein executing the computer-readable instructions further comprising:
capturing image files and text files of two or more pages of the reading article by one or more input devices while a user is reading the reading article;
capturing voice files, utilizing the one or more microphones of the robot computing device, of the user reading the reading article;
converting the captured voice files to voice text files;
generating measurements and/or parameters of the user's reading of the reading article by analyzing the voice text files;
analyzing the captured images files, text files and/or voice text files to identify characteristics of the reading article, the identified characteristics of the reading article including genre, plot, mood, or one or more characters of the reading article;
storing the identified characteristics of the reading article in an asset database and associating the identified characteristics with a reading article title;
generating augmented content files for one or more portions of the reading article based at least in part on the identified characteristics of the reading article, and
storing the augmented content files in the asset database and associating the augmented content files with different portions of the reading article.

21. The method of claim 20, wherein executing the computer-readable instructions further comprising: determining a user's progression of the user's reading of the reading article by reviewing the captured measurements and/or parameters from the one or more microphones.

22. The method of claim 20, wherein executing the computer-readable instructions further comprising:
retrieving augmented content files from an asset database, the retrieval of the augmented content files based at least in part on the captured measurements and/or parameters and the user's progression in reading the reading article; and
transmitting the one or more augmented content files to at least one of the one or more multimodal output devices for presentation by the robot computing device to the user.
